(19) United States
(12) Patent Application Publication
(10) Pub. No.: US 2013/0323588 A1
(43) Pub. Date: Dec. 5, 2013

(54) ELECTRODE BINDER COMPOSITION, ELECTRODE SLURRY, ELECTRODE, ELECTROCHEMICAL DEVICE, METHOD FOR PRODUCING ELECTRODE BINDER COMPOSITION, AND METHOD FOR STORING ELECTRODE BINDER COMPOSITION

(71) Applicants: Ichiro Kajiwara, Yokkaichi-shi (JP); Fusazumi Masaka, Funabashi-shi (JP); Takeshi Mogi, Yokkaichi-shi (JP); Daisuke Sukeguchi, Nagoya-shi (JP); Tatsuaki honda, Yokkaichi-shi (JP)

(72) Inventors: Ichiro Kajiwara, Yokkaichi-shi (JP); Fusazumi Masaka, Funabashi-shi (JP); Takeshi Mogi, Yokkaichi-shi (JP); Daisuke Sukeguchi, Nagoya-shi (JP); Tatsuaki honda, Yokkaichi-shi (JP)

(73) Assignee: JSR Corporation, Tokyo (JP)

(21) Appl. No.: 13/977,255

(22) PCT Filed: Dec. 8, 2011
(86) PCT No.: PCT/JP11/78373

§ 371 Date: Aug. 15, 2013

(30) Foreign Application Priority Data
Dec. 28, 2010 (JP) 2010-291863
Jan. 14, 2011 (JP) 2011-005871

(51) Int. Cl. H01G 11/30; B07B 1/00; H01M 4/62

(52) U.S. Cl. CPC H01G 11/30; H01M 4/622; B07B 1/00
USPC 429/211; 429/217; 53/440; 209/2; 361/502

(57) ABSTRACT

An electrode binder composition includes polymer particles. The polymer particles include 5 to 40 parts by mass of a constituent unit (A) derived from an alpha,beta-unsaturated nitrile compound, and 0.3 to 10 parts by mass of a constituent unit (B) derived from an unsaturated carboxylic acid, and have a number average particle size of 50 to 400 nm. The electrode binder composition has a gel content of 90 to 99% and an electrolyte solution swelling ratio of 110 to 400%.

### TECHNICAL FIELD

The present invention relates to an electrode binder composition, an electrode slurry that includes the electrode binder composition and an active material, an electrode that is produced by applying the electrode slurry to a collector, an electrochemical device that includes the electrode, a method for producing the electrode binder composition, and a method for storing the electrode binder composition.

### BACKGROUND ART

In recent years, a high-voltage electrical storage device having a high energy density has been desired as a power supply for driving an electronic instrument. In particular, a lithium-ion secondary battery or a lithium-ion capacitor is expected to be a high-voltage electrical storage device having a high energy density.

An electrode used for such an electrical storage device is produced by applying a mixture of an active material and an electrode binder to a collector, and drying the applied mixture. The electrode binder is required to exhibit an improved capability to bind the active material and bond the active material and the collector (hereinafter may be referred to as “binding/bonding capability”), scratch resistance when winding the electrode, and powder fall resistance (i.e., a fine powder of the active material or the like does not fall from an electrode composition layer (hereinafter may be referred to as “active material layer”) due to cutting or the like), for example. When the electrode binder meets these requirements, it is possible to produce an electrical storage device that has high flexibility in design (e.g., an electrode folding method and an electrode winding radius), and can be reduced in size. It is also desired to reduce the internal resistance of the battery due to the electrode binder. Excellent charge-discharge characteristics can be implemented by reducing the internal resistance of the battery.

For example, JP-A-2000-299109 discloses a technique that aims at improving the above characteristics by controlling the composition of the electrode binder. JP-A-2010-205722 and JP-A-2010-3703 disclose a technique that aims at improving the above characteristics by utilizing a binder that includes an epoxy group or a hydroxyl group. JP-A-2010-245035 discloses a technique that controls the residual impurity content in the binder.

### SUMMARY OF THE INVENTION

### Technical Problem

However, since such a binder composition serves as a resistance component of the electrode, it has been difficult to achieve excellent charge-discharge characteristics and an excellent binding/bonding capability in combination. It has been more difficult to maintain excellent charge-discharge characteristics and an excellent binding/bonding capability for a long time.

Since the electrode binder composition is prepared in a state in which organic particles are dispersed in a dispersion medium, aggregates may be formed due to a post-production process or a change in storage environment. The resulting electrode may be short-circuited due to such aggregates, and an electrochemical device produced using a binder composition that contains such aggregates may develop a problem (e.g., ignition) when the electrode has been short-circuited. Therefore, development of a novel binder that rarely undergoes aggregation (i.e., contains no or only a small amount of foreign substances), and can produce an electrode that is rarely short-circuited, has been desired. Development of a method for storing an electrode binder composition that prevents formation of foreign substances has also been desired.

Several aspects of the invention solve the above problems, and may provide an electrode binder composition that can produce an electrode that exhibits an excellent binding/bonding capability and excellent charge-discharge characteristics. Several aspects of the invention may provide an electrode binder composition that can produce an electrode that maintains an excellent binding/bonding capability and excellent charge-discharge characteristics for a long time.

Several aspects of the invention solve the above problems, and may provide an electrode binder composition that can be used as a material for forming an electrode for an electrochemical device that is highly safe, significantly reduces the incidence of a problem in which the separator is damaged, and rarely undergoes ignition and the like.

Several aspects of the invention may provide a method for storing an electrode binder composition that prevents formation of foreign substances, and improves the yield of electrodes.

### Solution to Problem

The invention was conceived in order to solve at least some of the above problems, and may be implemented as the following aspects or application examples.

### Application Example 1

According to one aspect of the invention, an electrode binder composition includes polymer particles, the polymer particles including 5 to 40 parts by mass of a constituent unit (A) derived from an alpha,beta-unsaturated nitrile compound, and 0.3 to 10 parts by mass of a constituent unit (B) derived from an unsaturated carboxylic acid, and having a number average particle size of 50 to 400 nm, the electrode binder composition having a gel content of 90 to 99% and an electrolyte solution swelling ratio of 110 to 400%.

### Application Example 2

In the electrode binder composition according to Application Example 1, the polymer particles may further include a constituent unit derived from a compound represented by the following general formula (I),

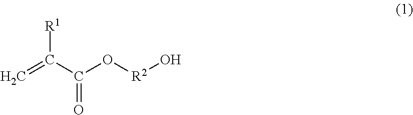

wherein R¹ is a hydrogen atom or a monovalent hydrocarbon group, and R² is a divalent hydrocarbon group.

### Application Example 3

In the electrode binder composition according to Application Example 2, the compound represented by the general formula (I) may be hydroxyethyl methacrylate.

### Application Example 4

In the electrode binder composition according to any one of Application Examples 1 to 3, the polymer particles may further include a constituent unit (C) derived from a conjugated diene compound.

### Application Example 5

The electrode binder composition according to any one of Application Examples 1 to 4 may have a pH of 6 to 8.

### Application Example 6

In the electrode binder composition according to any one of Application Examples 1 to 5, the number (per ml) of particles having a particle size of 20 micrometers or more measured using a particle counter may be zero.

### Application Example 7

According to another aspect of the invention, a method for producing an electrode binder composition includes filtering an electrode binder composition so that the number (per ml) of particles having a particle size of 20 micrometers or more measured using a particle counter is zero.

### Application Example 8

According to another aspect of the invention, an electrode slurry includes an active material and the electrode binder composition according to any one of Application Examples 1 to 6.

### Application Example 9

According to another aspect of the invention, an electrode includes a collector and an active material layer, the active material layer being formed by applying the electrode slurry according to Application Example 8 to a surface of the collector, and drying the applied electrode slurry.

### Application Example 10

According to another aspect of the invention, an electrochemical device includes the electrode according to Application Example 9.

### Application Example 11

According to another aspect of the invention, a method for storing an electrode binder composition includes charging a container that is controlled at a temperature of 2 to 30° C. with the electrode binder composition according to any one of Application Examples 1 to 6 so that the ratio of the volume of a void to the internal volume of the container is 1 to 20%, the volume of the void being calculated by subtracting a volume occupied by the electrode binder composition from the internal volume of the container.

### Application Example 12

In the method for storing an electrode binder composition according to Application Example 11, the oxygen concentration in the atmosphere contained in the void may be 1% or less.

### Application Example 13

In the method for storing an electrode binder composition according to Application Example 11 or 12, elution of metal ions from the container may occur at a concentration of 50 ppm or less.

### Advantageous Effects of the Invention

The electrode binder composition according to one aspect of the invention can produce an electrode that exhibits an excellent binding/bonding capability and excellent charge-discharge characteristics. The electrode binder composition according to one aspect of the invention can produce an electrode that maintains an excellent binding/bonding capability and excellent charge-discharge characteristics for a long time.

The method for storing an electrode binder composition according to one aspect of the invention can prevent formation of foreign substances, and improve the yield of electrodes.

### BRIEF DESCRIPTION OF DRAWINGS

FIG. 1 is a view schematically illustrating a filtration system used for a method for producing an electrode binder composition according to one embodiment of the invention.

### DESCRIPTION OF EMBODIMENTS

Exemplary embodiments of the invention are described below. Note that the invention is not limited to the following exemplary embodiments. Various modifications, improvements, and the like may be made of the following exemplary embodiments without departing from the scope of the invention based on the common knowledge of a person having ordinary skill in the art.

### 1. Electrode Binder Composition

An electrode binder composition according to one embodiment of the invention includes polymer particles, the polymer particles including 5 to 40 parts by mass of a constituent unit (A) derived from an alpha,beta-unsaturated nitrile compound, and 0.3 to 10 parts by mass of a constituent unit (B) derived from an unsaturated carboxylic acid, and having a number average particle size of 50 to 400 nm, characterized in that a polymer obtained by coagulating the polymer particles has a toluene insoluble content (gel content) of 90 to 99%, and a continuous film obtained by drying the polymer particles has a swelling ratio (electrolyte solution swelling ratio) of 110 to 400% when immersed in a standard electrolyte solution.

The electrode binder composition according to one embodiment of the invention is used as a binder for an active material. More specifically, the electrode binder composition according to one embodiment of the invention is used as a binder that binds the particles of a cathode active material, and bonds the cathode active material and a collector metal foil, or used as a binder that binds the particles of an anode active material, and bonds the anode active material and a collector metal foil. An electrode slurry may be prepared by mixing 100 parts by mass of the cathode active material or the anode active material and 0.1 to 10 parts by mass (preferably 0.5 to 5 parts by mass) (based on the solid content) of the polymer particles. If the amount of the polymer particles is less than 0.1 parts by mass, the binding/bonding capability may deteriorate. If the amount of the polymer particles exceeds 10 parts by mass, the battery characteristics tend to be adversely affected. Each component included in the electrode binder composition according to one embodiment of the invention is described in detail below.

### 1.1. Polymer Particles

The polymer particles included in the electrode binder composition according to one embodiment of the invention include the constituent unit (A) derived from an alpha,beta-unsaturated nitrile compound (hereinafter may be referred to as “constituent unit (A)”), and the constituent unit (B) derived from an unsaturated carboxylic acid (hereinafter may be referred to as “constituent unit (B)”). Note that the term “constituent unit” used herein refers to a repeating unit that forms a polymer obtained by polymerizing a monomer (i.e., a repeating unit derived from the monomer).

### 1.1.1. Constituent Unit (A) Derived from Alpha,Beta-Unsaturated Nitrile Compound

The constituent unit (A) allows the polymer particles to moderately swell in an electrolyte solution. More specifically, the solvent contained in the electrolyte solution enters the network structure formed by the polymer chains, and increases the space of the network structure. Therefore, solvated lithium ions can easily pass through the network structure. It is considered that the diffusion capability of lithium ions is thus improved. As a result, the resulting electrode exhibits excellent charge-discharge characteristics due to a decrease in resistance.

Specific examples of the alpha,beta-unsaturated nitrile compound that is used to form the constituent unit (A) include acrylonitrile, methacrylonitrile, alpha-chloroacrylonitrile, alpha-ethylacrylonitrile, vinylidene cyanide, and the like. Among these, acrylonitrile and methacrylonitrile are preferable, and acrylonitrile is particularly preferable. The polymer particles may include only one type of the constituent unit (A), or may include two or more types of the constituent unit (A).

The constituent unit (A) is used in an amount of 5 to 40 parts by mass, preferably 7 to 35 parts by mass, and more preferably 10 to 30 parts by mass, based on 100 parts by mass of the total constituent units. When the amount of the constituent unit (A) is within the above range, the polymer particles exhibit excellent affinity to the electrolyte solution while exhibiting a moderate swelling ratio, and contribute to an improvement in battery characteristics.

### 1.1.2. Constituent Unit (B) Derived from Unsaturated Carboxylic Acid

When the polymer particles include the constituent unit (B), a mixture (slurry) can be prepared by mixing the electrode binder composition according to one embodiment of the invention with the active material so that the active material is well dispersed without undergoing aggregation. Therefore, an electrode produced by applying the mixture has an almost uniform distribution, and shows only a small number of binding/bonding defects. Specifically, the binding/bonding capability is improved by the constituent unit (B).

Specific examples of the unsaturated carboxylic acid that is used to form the constituent unit (B) include mono- or dicarboxylic acids (anhydrides) such as acrylic acid, methacrylic acid, crotonic acid, maleic acid, fumaric acid, and itaconic acid, and the like. Among these, acrylic acid, methacrylic acid, and itaconic acid are particularly preferable. The polymer particles may include only one type of the constituent unit (B), or may include two or more types of the constituent unit (B).

The constituent unit (B) is used in an amount of 0.3 to 10 parts by mass, and preferably 0.3 to 6 parts by mass, based on 100 parts by mass of the total constituent units. When the amount of the constituent unit (B) is within the above range, the polymer particles exhibit excellent dispersion stability (i.e., aggregates are rarely formed) when preparing an electrode slurry. Moreover, an increase in viscosity of the slurry with the passage of time can be suppressed.

### 1.1.3. Constituent Unit (C) Derived from Conjugated Diene Compound

The polymer particles included in the electrode binder composition according to one embodiment of the invention preferably further include a constituent unit (C) derived from a conjugated diene compound (hereinafter may be referred to as “constituent unit (C)”).

The polymer particles exhibit a high binding/bonding capability due to the constituent unit (C). More specifically, since the polymer particles are provided with the rubber elasticity of the conjugated diene compound, the polymer particles can follow a change in volume (e.g., shrinkage or expansion) of the electrode. The polymer particles thus exhibit an improved binding/bonding capability, and also exhibit durability that maintains the charge-discharge characteristics for a long time.

Specific examples of the conjugated diene compound that is used to form the constituent unit (C) include 1,3-butadiene, 2-methyl-1,3-butadiene, 2,3-dimethyl-1,3-butadiene, 2-chloro-1,3-butadiene, substituted linear conjugated pentadienes, substituted side-chain conjugated hexadienes, and the like. Among these, 1,3-butadiene is particularly preferable. The polymer particles may include only one type of the constituent unit (C), or may include two or more types of the constituent unit (C).

The constituent unit (C) is preferably used in an amount of 60 parts by mass or less, more preferably 25 to 55 parts by mass, and particularly preferably 35 to 50 parts by mass, based on 100 parts by mass of the total constituent units. When the amount of the constituent unit (C) is within the above range, the binding/bonding capability can be further improved.

### 1.1.4. Constituent Unit (D) Derived from Aromatic Vinyl Compound

The polymer particles included in the electrode binder composition according to one embodiment of the invention preferably further include a constituent unit (D) derived from an aromatic vinyl compound (hereinafter may be referred to as “constituent unit (D)”).

Specific examples of the aromatic vinyl compound that is used to form the constituent unit (D) include styrene, alpha-methylstyrene, p-methylstyrene, vinyltoluene, chlorostyrene, divinylbenzene, and the like. Among these, styrene is particularly preferable. The polymer particles may include only one type of the constituent unit (D), or may include two or more types of the constituent unit (D).

The constituent unit (D) is preferably used in an amount of 60 parts by mass or less, more preferably 10 to 55 parts by mass, and particularly preferably 20 to 50 parts by mass, based on 100 parts by mass of the total constituent units. When the amount of the constituent unit (D) is within the above range, the polymer particles exhibit a moderate capability to bind graphite that may be used as the active material. Moreover, the resulting electrode layer exhibits excellent flexibility and excellent adhesion to the collector.

### 1.1.5. Constituent Unit (E) Derived from (Meth)Acrylate Compound

The polymer particles included in the electrode binder composition according to one embodiment of the invention preferably further include a constituent unit (E) derived from a (meth)acrylate compound (hereinafter may be referred to as “constituent unit (E)”). Note that the term “(meth)acrylate” used herein refers to “acrylate” and “methacrylate”.

When the electrode binder composition includes the polymer particles that include the constituent unit (A) and do not include the constituent unit (E), the polymer particles exhibit a high swelling ratio in the electrolyte solution, and the resistance of the electrode decreases. However, the binding/bonding capability to bind the active material and bond the active material layer and the collector may decrease (i.e., the electrode structure may not be sufficiently maintained), and the charge-discharge characteristics may deteriorate. In contrast, when the electrode binder composition includes the polymer particles that include the constituent unit (A) and the constituent unit (E), it is possible to ensure that the polymer particles exhibit a high swelling ratio in the electrolyte solution (i.e., the resistance of the electrode decreases) while sufficiently retaining the active material due to the synergistic effects of the constituent unit (A) and the constituent unit (E).

A compound represented by the following general formula (I) is preferable as the (meth)acrylate compound that is used to form the constituent unit (E).

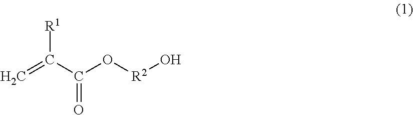

R¹ in the general formula (I) is a hydrogen atom or a monovalent hydrocarbon group, preferably a monovalent hydrocarbon group, more preferably a substituted or unsubstituted alkyl group having 1 to 6 carbon atoms, and particularly preferably a methyl group. R² is a divalent hydrocarbon group, and preferably a substituted or unsubstituted alkylene group having 1 to 6 carbon atoms. Specific examples of the compound represented by the general formula (I) that is used to form the constituent unit (E) include 2-hydroxyethyl methacrylate, 2-hydroxypropyl methacrylate, 3-hydroxypropyl methacrylate, 4-hydroxybutyl methacrylate, 5-hydroxypentyl methacrylate, 6-hydroxyhexyl methacrylate, and the like. Among these, 2-hydroxyethyl methacrylate is preferable. The polymer particles may include only one type of the constituent unit (E), or may include two or more types of the constituent unit (E).

The polymer particles included in the electrode binder composition according to one embodiment of the invention may include the constituent unit (E) derived from a (meth)acrylate compound other than the compound represented by the general formula (1). Specific examples of the (meth)acrylate compound other than the compound represented by the general formula (1) include methyl(meth)acrylate, ethyl(meth)acrylate, n-propyl(meth)acrylate, isopropyl(meth)acrylate, n-butyl(meth)acrylate, isobutyl(meth)acrylate, n-amyl(meth)acrylate, i-amyl(meth)acrylate, hexyl(meth)acrylate, 2-hexyl(meth)acrylate, octyl(meth)acrylate, isononyl(meth)acrylate, decyl(meth)acrylate, and the like. Among these, methyl(meth)acrylate, n-butyl(meth)acrylate, and isobutyl(meth)acrylate are preferable, and methyl(meth)acrylate is more preferable. The polymer particles may include only one type of the constituent unit (E) derived from a (meth)acrylate compound other than the compound represented by the general formula (1), or may include two or more types of the constituent unit (E) derived from a (meth)acrylate compound other than the compound represented by the general formula (1).

The constituent unit (E) is preferably used in an amount of 40 parts by mass or less, more preferably 5 to 35 parts by mass, and particularly preferably 10 to 30 parts by mass, based on 100 parts by mass of the total constituent units. When the constituent unit (E) is derived from the compound represented by the general formula (1), the constituent unit (E) is preferably used in an amount of 20 parts by mass or less, more preferably 1 to 10 parts by mass, and particularly preferably 2 to 5 parts by mass, based on 100 parts by mass of the total constituent units. When the amount of the constituent unit (E) is within the above range, the resulting polymer particles exhibit moderate affinity to the electrolyte solution. This makes it possible to suppress an increase in internal resistance that may occur when the electrode binder composition serves as an electrical resistance component in the battery. It is also possible to prevent a decrease in binding/bonding capability due to excessive absorption of the electrolyte solution.

### 1.1.6. Constituent Unit Derived from Additional Copolymerizable Monomer

The polymer particles included in the electrode binder composition according to one embodiment of the invention may include a constituent unit derived from a monomer compound that is copolymerizable with the above compounds (hereinafter may be referred to as “additional copolymerizable monomer”).

Specific examples of the additional copolymerizable monomer include alkylamides of an ethylenically unsaturated carboxylic acid, such as (meth)acrylamide and N-methylolacrylamide; vinyl carboxylates such as vinyl acetate and vinyl propionate; ethylenically unsaturated dicarboxylic anhydrides; monoalkyl esters; monoamides; aminoalkylamides of an ethylenically unsaturated carboxylic acid, such as aminoethylacrylamide, dimethylaminomethylmethacrylamide, and methylaminopropylmethacrylamide; and the like. These additional copolymerizable monomers may be used either alone or in combination. A crosslinkable copolymerizable monomer may be used in combination with these additional copolymerizable monomers.

### 1.1.7. Number Average Particle Size of Polymer Particles

The polymer particles have a number average particle size of 50 to 400 nm, and preferably 70 to 350 nm. When the number average particle size of the polymer particles is within the above range, the binding/bonding capability tends to be improved during a drying step performed when forming an electrode. Moreover, the resulting electrode tends to have a configuration in which a sufficient number of effective bonding points are formed between the active material, the polymer particles, and the collector. The number average particle size of the polymer particles may be determined using a particle size distribution analyzer that utilizes the dynamic light scattering method as the measurement principle.

Examples of such a particle size distribution analyzer include Coulter LS 230, Coulter LS 100, Coulter LS 13 320 (manufactured by Beckman Coulter, Inc.), ALV-5000 (manufactured by ALV), FPAR-1000 (Otsuka Electronics Co., Ltd.), and the like. These particle size distribution analyzers can measure the particle size distribution of the primary particles of the polymer particles, and can also measure the particle size distribution of the secondary particles that are formed by aggregation of the primary particles. Therefore, the particle size distribution measured by these particle size distribution analyzers can be used as an index of the dispersion state of the polymer particles included in the electrode slurry. Note that the number average particle size of the polymer particles may also be measured by centrifuging the electrode slurry to precipitate the particles of the active material, and analyzing the supernatant liquid using the particle size distribution analyzer.

### 1.1.8. Glass Transition Temperature (Tg) of Polymer Particles

It is preferable that the polymer particles have a glass transition temperature (Tg) measured by differential scanning calorimetry (DSC) in accordance with JIS K 7121, of −50 to 25° C., and more preferably −30 to 5° C. When the glass transition temperature of the polymer particles is within the above range, the polymer particles can provide the active material layer with better flexibility and adhesion (i.e., the binding/bonding capability can be further improved).

### 1.2. Production of Polymer Particles

The polymer particles included in the electrode binder composition according to one embodiment of the invention may be synthesized by an arbitrary method. The polymer particles can be easily produced by two-stage emulsion polymerization.

### 1.2.1. First-Stage Polymerization Step

A monomer component (I) that is used for the first-stage emulsion polymerization step includes a non-carboxylic acid monomer (e.g., alpha,beta-unsaturated nitrile compound, conjugated diene compound, aromatic vinyl compound, (meth)acrylate compound, and additional copolymerizable monomer) and a carboxylic acid monomer (e.g., unsaturated carboxylic acid), for example. The content of the non-carboxylic acid monomer in the monomer component (I) is preferably 80 to 92 mass %, and more preferably 82 to 92 mass %, based on the total content (=100 mass %) of the non-carboxylic acid monomer and the carboxylic acid monomer. When the content of the non-carboxylic acid monomer is 80 to 92 mass %, the polymer particles exhibit excellent dispersion stability (i.e., aggregates are rarely formed) when preparing an electrode slurry. Moreover, an increase in viscosity of the slurry with the passage of time can be suppressed.

The content of the (meth)acrylate compound in the non-carboxylic acid monomer included in the monomer component (I) is preferably 14 to 30 mass %. When the content of the (meth)acrylate compound is within the above range, the polymer particles exhibit excellent dispersion stability (i.e., aggregates are rarely formed) when preparing an electrode slurry. Moreover, since the resulting polymer particles exhibit moderate affinity to the electrolyte solution, it is possible to prevent a decrease in binding/bonding capability due to excessive absorption of the electrolyte solution.

The content of the conjugated diene compound in the non-carboxylic acid monomer included in the monomer component (I) is preferably 10 to 60 mass %. The content of the aromatic vinyl compound in the non-carboxylic acid monomer is preferably 20 to 50 mass %. The content of itaconic acid in the carboxylic acid monomer is preferably 50 to 85 mass %.

### 1.2.2. Second-Stage Polymerization Step

A monomer component (II) that is used for the second-stage emulsion polymerization step includes a non-carboxylic acid monomer (e.g., alpha,beta-unsaturated nitrile compound, conjugated diene compound, aromatic vinyl compound, (meth)acrylate compound, and additional copolymerizable monomer) and a carboxylic acid monomer (e.g., unsaturated carboxylic acid), for example. The content of the non-carboxylic acid monomer in the monomer component (II) is preferably 94 to 99 mass %, and more preferably 96 to 98 mass %, based on the total content (=100 mass %) of the non-carboxylic acid monomer and the carboxylic acid monomer. When the content of the non-carboxylic acid monomer is within the above range, the polymer particles exhibit excellent dispersion stability (i.e., aggregates are rarely formed) when preparing an electrode slurry. Moreover, an increase in viscosity of the slurry with the passage of time can be suppressed.

The content of the (meth)acrylate compound in the non-carboxylic acid monomer included in the monomer component (II) is preferably 11.5 mass % or less. When the content of the (meth)acrylate compound is 11.5 mass % or less, the resulting polymer particles exhibit moderate affinity to the electrolyte solution. This makes it possible to prevent a decrease in binding/bonding capability due to excessive absorption of the electrolyte solution.

The mass ratio “(I)/(II)” of the monomer component (I) to the monomer component (II) is preferably 0.05 to 0.5, and more preferably 0.1 to 0.4. When the mass ratio “(I)/(II)” is within the above range, the polymer particles exhibit excellent dispersion stability (i.e., aggregates are rarely formed) when preparing an electrode slurry. Moreover, an increase in viscosity of the slurry with the passage of time can be suppressed.

### 1.2.3. Emulsion Polymerization

The monomer component is subjected to emulsion polymerization in an aqueous medium in the presence of an emulsifier, an initiator, and a molecular weight modifier. Each material used for emulsion polymerization is described below.

### 1.2.3.1. Emulsifier

Specific examples of the emulsifier include anionic surfactants such as higher alcohol sulfate salts, alkylbenzenesulfonates, alkyl diphenyl ether disulfonates, aliphatic sulfonates, aliphatic carboxylates, dehydroabietates, a naphthalenesulfonic acid-formalin condensate, and sulfate salts of a nonionic surfactant; nonionic surfactants such as polyethylene glycol alkyl esters, polyethylene glycol alkyl phenyl ethers, and polyethylene glycol alkyl ethers; and fluorine-based surfactants such as perfluorobutylsulfonates, perfluoroalkyl group-containing phosphates, perfluoroalkyl group-containing carboxylates, and perfluoroalkyl ethylene oxide adducts. Note that these emulsifiers may be used for emulsion polymerization either alone or in combination.

### 1.2.3.2. Initiator

Specific examples of the initiator include water-soluble initiators such as lithium persulfate, potassium persulfate, sodium persulfate, and ammonium persulfate; and oil-soluble initiators such as cumene hydroperoxide, benzoyl peroxide, t-butyl hydroperoxide, acetyl peroxide, diisopropylbenzene hydroperoxide, and 1,1,3,3-tetramethylbutyl hydroperoxide. Among these, potassium persulfate, sodium persulfate, cumene hydroperoxide, and t-butyl hydroperoxide are preferable. Note that these initiators may be used for emulsion polymerization either alone or in combination. The initiator is used in an appropriate amount taking account of the monomer composition, the pH of the polymerization system, the type of additional additive, and the like.

### 1.2.3.3. Molecular Weight Modifier

Specific examples of the molecular weight modifier include alkylmercaptans such as n-hexylmercaptan, n-octylmercaptan, t-octylmercaptan, n-dodecylmercaptan, t-dodecylmercaptan, and n-stearylmercaptan; xanthogen compounds such as dimethylxanthogen disulfide and diisopropylxanthogen disulfide; thiuram compounds such as terpinolene, tetramethylthiuram disulfide, tetraethylthiuram disulfide, and tetramethylthiuram monosulfide; phenol compounds such as 2,6-di-t-butyl-4-methylphenol and styrenated phenol; allyl compounds such as allyl alcohols; halogenated hydrocarbon compounds such as dichloromethane, dibromomethane, and carbon tetrabromide; vinyl ether compounds such as alpha-benzyloxystyrene, alpha-benzyloxyacrylonitrile, and alpha-benzyloxyacrylamide; triphenylethane; pentaphenylethane; acrolein; methacrolein; thioglycolic acid; thiomalic acid; 2-ethylhexyl thioglycolate; an alpha-methylstyrene dimer; and the like. Note that these molecular weight modifiers may be used for emulsion polymerization either alone or in combination.

### 1.2.4. Emulsion Polymerization Conditions

The first-stage emulsion polymerization step is preferably performed at 40 to 80° C. for 2 to 4 hours. The polymerization conversion rate in the first-stage emulsion polymerization step is preferably 50% or more, and more preferably 60% or more. The second-stage emulsion polymerization step is preferably performed at 40 to 80° C. for 2 to 6 hours.

After completion of emulsion polymerization, the resulting dispersion is preferably neutralized by adding a neutralizer so that the dispersion has a pH of about 5 to about 10. The neutralizer is not particularly limited. Examples of the neutralizer include metal hydroxides (e.g., sodium hydroxide and potassium hydroxide) and ammonia. The dispersion exhibits excellent dispersion stability as a result of adjusting the pH of the dispersion to 5 to 10. The pH of the dispersion is preferably adjusted to 6 to 9, more preferably 6 to 8, and still more preferably 7 to 8.5. Emulsion polymerization proceeds with excellent dispersion stability when the total solid content in the reaction mixture is adjusted to 50 mass % or less. The total solid content is preferably adjusted to 45 mass % or less, and more preferably 40 mass % or less. The neutralized dispersion may be concentrated so as to increase the solid content in the dispersion while improving the stability of the particles.

### 1.3. Additive

The electrode binder composition according to one embodiment of the invention may optionally include an additive such as a water-soluble thickener. Specific examples of the additive include water-soluble thickeners such as carboxymethyl cellulose, methyl cellulose, hydroxymethyl cellulose, ethyl cellulose, polyvinyl alcohol, polyacrylic acid (salt), oxidized starch, phosphorylated starch, and casein; dispersants such as sodium hexametaphosphate, sodium tripolyphosphate, sodium pyrophosphate, and sodium polyacrylate; and latex stabilizers such as a nonionic surfactant and an anionic surfactant.

### 1.4. Gel content

The electrode binder composition according to one embodiment of the invention has a gel content of 90 to 99%, preferably 92 to 99%, and more preferably 94 to 99%. When the gel content is within the above range, the polymer particles are dissolved in the electrolyte solution to only a small extent, and a situation in which the battery characteristics are adversely affected by an increase in overvoltage can be suppressed for a long time. If the gel content is less than the above range, the electrode binder composition may exhibit an insufficient capability to retain (secure) the active material for a long time. If the gel content exceeds the above range, adhesion to the collector may decrease.

The gel content in the electrode binder composition according to one embodiment of the invention is calculated as described below.

Methanol is added to the electrode binder composition to coagulate the electrode binder composition, and the coagulate is dried under vacuum to remove water. Toluene is added to the coagulate (W0 (g)) to swell and dissolve the coagulate. The solution is filtered through a 300-mesh wire gauze that has been weighed. Toluene is evaporated from the filtrate, and the mass (W1 (g)) of the dry substance is measured. The gel content (%) is calculated by the following expression (2) using the above values.

Gel content (%)=((W0−W1)/W0)×100 (2)

### 1.5. Electrolyte Solution Swelling Ratio

The electrode binder composition according to one embodiment of the invention has an electrolyte solution swelling ratio of 110 to 400%, preferably 130 to 350%, and more preferably 150 to 300%. When the electrolyte solution swelling ratio is within the above range, the polymer particles moderately swell in the electrolyte solution. As a result, solvated lithium ions easily reach the active material, and the resistance of the electrode can be effectively reduced to implement excellent charge/discharge characteristics. Moreover, since a large change in volume does not occur, an excellent binding/bonding capability can be achieved. If the electrolyte solution swelling ratio is less than the above range, an excellent binding/bonding capability is obtained, but lithium ions may not easily reach the active material, and the resistance of the electrode may increase. If the electrolyte solution swelling ratio exceeds the above range, the resistance of the electrode decreases, but the binding/bonding capability may deteriorate.

The electrolyte solution swelling ratio of the electrode binder composition according to one embodiment of the invention is calculated as described below.

The electrode binder composition is poured into a given frame, and dried at room temperature to obtain a dry film. The dry film is removed from the frame, and dried at 80° C. for 3 hours to obtain a test film. The test film (W0′ (g)) is immersed in a standard electrolyte solution, and heated at 80° C. for 1 day to swell the test film. After removing the test film from the standard electrolyte solution, the electrolyte solution present on the surface of the test film is wiped off, and the post-immersion mass (W1′ (g)) is measured. The electrolyte solution swelling ratio (%) is calculated by the following expression (3) using the above values.

Electrolyte solution swelling ratio (%)=(W1′/W0′)×100 (3)

Note that the term “standard electrolyte solution” used herein refers to an electrolyte solution prepared by dissolving LiPF₆ (electrolyte) (concentration: 1 M) in a mixed solvent prepared by mixing ethylene carbonate (EC) and diethyl carbonate (DEC) in a volume ratio of 5:5.

### 1.6. Additional Features

It is preferable that the number (per ml) of particles having a particle size of 20 micrometers or more in the electrode binder composition according to one embodiment of the invention measured using a particle counter be zero. When the number (per ml) of particles having a particle size of 20 micrometers or more measured using a particle counter is zero, the electrode binder composition can be used as a material for forming an electrode for an electrochemical device that is highly safe, and significantly reduces the incidence of a problem in which the separator is damaged due to the particles included in the binder (i.e., the particles pass through the separator).

It is considered that a known electrode binder composition contains particles having a particle size larger than a given particle size since a known electrode binder composition is prepared without removing such particles. In this case, when large particles are electrically charged when a current flows, the large particles may be attracted to the electrode through the separator, and pass through the separator, or cracks may occur in the separator due to the large particles. Specifically, the separator may be damaged (i.e., large particles pass through the separator, or cracks occur in the separator due to large particles) when using a known electrode binder composition. Since electricity flows through the separator when the separator is damaged, the electrochemical device may undergo a hard short circuit, and may ignite, for example. In contrast, since the electrode binder composition according to one embodiment of the invention does not contain particles (particles having a particle size larger than a given particle size) that may pass through the separator or produce cracks in the separator, it is possible to produce an electrode for a highly safe electrochemical device. Note that particles having a particle size larger than a given particle size refer to particles having a particle size almost equal to the thickness of the separator that separates the cathode and the anode. The thickness of the separator is normally 10 to 30 micrometers. If the thickness of the separator is less than 10 micrometers, the separator may be easily damaged (i.e., the electrochemical device may develop failure).

It is also preferable that the number (per ml) of particles having a particle size of 15 micrometers or more and less than 20 micrometers in the electrode binder composition according to one embodiment of the invention measured using a particle counter be 0 to 35,000, and more preferably 0 to 4000. It is preferable that the number (per ml) of particles having a particle size of more than 10 micrometers and less than 15 micrometers in the electrode binder composition according to one embodiment of the invention measured using a particle counter be 0 to 500,000, and more preferably 0 to 200,000. When the number of particles having a given particle size is within the above range, it is possible to further reduce the possibility that the separator is damaged due to the particles. The binder may serve as a resistance component, and an increase in resistance may easily occur when the binder is locally distributed. However, the binder is rarely locally distributed when the number of particles having a given particle size is within the above range. Therefore, an increase in resistance rarely occurs.

Note that the number (per ml) of particles included in the electrode binder composition according to one embodiment of the invention is measured using a particle counter, and the number of particles having a given particle size is specified.

The electrode binder composition according to one embodiment of the invention is obtained by polymerizing the polymerizable monomers. Specifically, the electrode binder composition according to one embodiment of the invention includes polymer particles that include structural units derived from the polymerizable monomers, and the polymer particles function as a binder.

The concentration (based on the solid content) of the polymer particles in the electrode binder composition according to one embodiment of the invention is preferably 20 to 56 mass %, more preferably 23 to 55 mass %, and particularly preferably 25 to 54 mass %. When the concentration of the polymer particles is within the above range, the polymer particles are stabilized in the binder composition (i.e., is present in the binder composition in a well-dispersed state), and the binder composition exhibits excellent long-term stability. If the concentration of the polymer particles is less than 20 mass %, productivity may decrease. Specifically, when using a reaction mixture obtained by polymerization directly as a binder, it is necessary to decrease the concentration of polymer particles obtained by polymerization. Therefore, productivity decreases. If the concentration of the polymer particles exceeds 56 mass %, the viscosity of the binder may increase to a large extent, and sufficient long-term stability may not be obtained.

### 1.7. Method for Producing Electrode Binder Composition

A method for producing an electrode binder composition according to one embodiment of the invention includes filtering a reaction mixture obtained by synthesizing polymer particles as described above through a depth-type filter or a pleat-type filter after optionally adding the additive to the reaction mixture, to obtain a filtrate in which the number (per ml) of particles having a particle size of 20 micrometers or more measured using a particle counter is zero. The method for producing an electrode binder composition according to one embodiment of the invention can produce an electrode binder composition that can be used to produce an electrode for an electrochemical device that is highly safe, and significantly reduces the incidence of a problem in which the separator is damaged due to the particles included in the binder (i.e., the particles pass through the separator).

The term “depth-type filter” used herein refers to a high-performance filter that is also referred to as “depth filtration filter” or “volume filtration filter”. The depth-type filter may have a stacked layer structure formed by stacking filtration membranes in which a number of pores are formed, or may be formed by rolling up a fiber bundle, for example. Specific examples of the depth-type filter include Profile II, Nexis NXA, Nexis NXT, Poly-fine XLD, Ultipleat Profile (manufactured by Pall Corporation), Depth Cartridge Filter, Wound Cartridge Filter (manufactured by Advantec Co., Ltd.), CP Filter, BM Filter (manufactured by Chisso Corporation), SLOPE-PURE, DIA, MICRO-CILIA (manufactured by Roki Techno Co., Ltd.), and the like.

It is preferable to use a depth-type filter having a nominal filtration rating of 1.0 to 20 micrometers, and more preferably 5.0 to 10 micrometers. When the nominal filtration rating is within the above range, it is possible to efficiently obtain a filtrate in which the number (per ml) of particles having a particle size of 20 micrometers or more measured using a particle counter is zero. Moreover, since the number of large particles trapped by the filter is minimized, the service life of the filter increases.

The term “pleat-type filter” used herein refers to a tubular high-performance filter that is obtained by pleating a microfiltration membrane sheet formed of a nonwoven fabric, filter paper, metal mesh, or the like, forming the microfiltration membrane sheet to have a tubular shape, liquid-tightly sealing the joint of the sheet, and liquid-tightly sealing each end of the tubular sheet.

It is preferable to use a pleat-type filter having a nominal filtration rating of 1.0 to 20 micrometers, and more preferably 5.0 to 10 micrometers. When the nominal filtration rating is within the above range, it is possible to efficiently obtain a filtrate in which the number (per ml) of particles having a particle size of 20 micrometers or more measured using a particle counter is zero. Moreover, since the number of large particles trapped by the filter is minimized, the service life of the filter increases.

Specific examples of the pleat-type filter include HDC II, Poly-fine XLD (manufactured by Pall Corporation), PP Pleated Cartridge Filter (manufactured by Advantec Co., Ltd.), Porous Fine (manufactured by Chisso Corporation), CERTAIN-PORE, MICRO-PURE (manufactured by Roki Techno Co., Ltd.), and the like.

The filtration conditions (e.g., the differential pressure across the filter and the liquid temperature) are not particularly limited as long as it is possible to obtain a filtrate in which the number (per ml) of particles having a particle size of 20 micrometers or more measured using a particle counter is zero. The differential pressure may be appropriately set as long as the maximum differential pressure of the filter is not exceeded, but is preferably 0.2 to 0.4 MPaG. The liquid temperature is preferably 10 to 50° C.

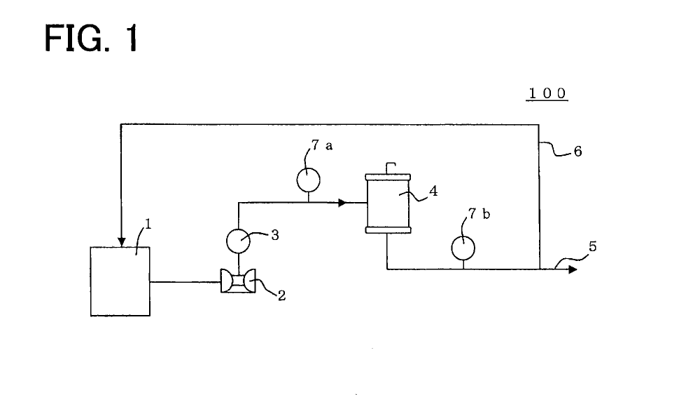

The filtration step may be performed using a filtration system 100 illustrated in FIG. 1, for example. The filtration system 100 includes a supply tank 1 that stores and supplies the electrode binder composition from which foreign substances have not been removed, a constant volume pump 2 that discharges the electrode binder composition (from which foreign substances have not been removed) at a constant flow rate, a filter 4 that includes a cartridge filter (not illustrated in FIG. 1) and a housing that receives (is fitted with) the cartridge filter, a pulsation protector 3 that is disposed between the constant volume pump 2 and the filter 4, a first manometer 7a that is disposed between the pulsation protector 3 and the filter 4, and a second manometer 7b that is disposed on the downstream side of the filter 4. The filtration system 100 also includes a return conduit 6 that returns the binder from the filter 4 to the supply tank 1, and a discharge conduit 5 that discharges the electrode binder composition filtered through the filter 4.

The filtration system 100 is configured so that the reaction mixture obtained by the polymerization step is supplied from the supply tank 1 to the pulsation protector 3 via the constant volume pump 2. The pulsation protector 3 reduces pulsation due to the constant volume pump 2. The reaction mixture discharged from the pulsation protector 3 is supplied to the filter 4 to remove foreign substances, and collected through the discharge conduit 5. The collected liquid is used as the electrode binder composition. Note that the term “foreign substance” used herein refers to a particle having a particle size of 20 micrometers or more.

When foreign substances have not been sufficiently removed from the liquid collected through the discharge conduit 5, the collected liquid may be returned to the supply tank 1 through the return conduit 6, and again filtered through the filter 4. The pulsation protector 3 may not be disposed when pulsation due to the constant volume pump 2 does not occur. When the viscosity of the reaction mixture is high, the viscosity of the reaction mixture may be reduced by heating either or both of the supply tank and the conduit. Specifically, the filtration system 100 may further include a heating means that can heat either or both of the supply tank and the conduit. This makes it possible to improve productivity when the viscosity of the reaction mixture is high.

Note that the filtration system 100 may not include the first manometer 7a and the second manometer 7b. However, it is desirable to provide the first manometer 7a and the second manometer 7b in order to manage the differential pressure across the filter so that the filter functions normally. The electrode binder composition from which foreign substances have not been removed may be supplied directly from a transport container instead of the supply tank 1. The filtration system 100 may include a plurality of filters 4. In this case, the plurality of filters may be connected in series, or may be disposed in parallel.

### 1.8. Method for Storing Electrode Binder Composition

A method for storing an electrode binder composition (hereinafter may be referred to as “storage method”) according to one embodiment of the invention may suitably be used for an electrode binder composition that is produced by the above method and characterized in that the number (per ml) of particles having a particle size of 20 micrometers or more is zero. The storage method according to one embodiment of the invention is particularly effective when the polymer particles included in the electrode binder composition include a fluorine-based polymer that tends to aggregate.

The storage method according to one embodiment of the invention includes storing the electrode binder composition at a temperature of 2 to 30° C. (preferably 10 to 25° C.). If the temperature exceeds the above range, the polymer particles may aggregate at the gas-liquid interface formed along the wall surface of a container during long-term storage (i.e., the electrode binder composition may not be stably stored). If the temperature is less than the above range, the polymer particles may gel or aggregate in the liquid (i.e., the electrode binder composition may not be stably stored).

The storage method according to one embodiment of the invention stores the electrode binder composition in a container having a void ratio of 1 to 20%, preferably 3 to 15%, and more preferably 5 to 10%, the void ratio being the ratio (%) of the volume of a void to the internal volume of the container, the volume of the void being calculated by subtracting the volume occupied by the electrode binder composition from the internal volume of the container. If the void ratio exceeds the above range, water may significantly volatilize when the storage temperature has changed, and the polymer particles may aggregate at the gas-liquid interface (i.e., the electrode binder composition may not be stably stored). If the void ratio is less than the above range, the container may be deformed or burst when the volume of the electrode binder composition has changed due to a change in temperature (i.e., the electrode binder composition may not be stably stored).

In the storage method according to one embodiment of the invention, it is preferable that the oxygen concentration in the atmosphere contained in the void be 1% or less. When the oxygen concentration in the atmosphere contained in the void is within the above range, the binder component is not oxidized and does not show a change in properties during long-term storage, and a situation in which the polymer particles aggregate can be effectively suppressed.

In the storage method according to one embodiment of the invention, it is preferable that elution of metal ions from the container used to store the electrode binder composition occur at a concentration of 50 ppm or less. If metal ions are eluted into the composition, the zeta potential balance of the surface of the polymer particles dispersed in the composition may be lost, and the polymer particles may easily aggregate. The aggregated particles are likely to form a fatal conductive path when forming the active material layer.

It is preferable that the container be formed of glass or a resin material in order to reduce the amount of metal elution. For example, it is preferable to use a clean container produced by the method disclosed in JP-A-59-035043 or the like.

The storage method according to one embodiment of the invention ensures that the properties (quality) of the electrode binder composition change to only a small extent even when the electrode binder composition is stored for 6 months (preferably 12 months, and more preferably 18 months). Moreover, a gel-like substance is not formed. Therefore, the active material layer can be formed under the same conditions as those employed when forming the active material layer using the electrode binder composition immediately after production. The effect of improving the productivity of the electrode binder composition increases as the storage period increases (e.g., 6 months→12 months→18 months).

### 2. Electrode Slurry

An electrode slurry according to one embodiment of the invention includes an active material and the electrode binder composition. Since the electrode slurry according to one embodiment of the invention includes the electrode binder composition, it is possible to produce an electrode that exhibits an excellent binding/bonding capability and excellent charge-discharge characteristics. The electrode is highly safe, and significantly reduces the incidence of a problem in which the separator is damaged due to the particles included in the binder (i.e., the particles pass through the separator).

### 2.1. Active Material

The active material is not particularly limited. When producing an electrode for a lithium-ion secondary battery, carbon may be used as the anode active material. Specific examples of carbon include a carbon material that is obtained by calcining an organic polymer compound (e.g., phenol resin, polyacrylonitrile, or cellulose); a carbon material that is obtained by calcining coke or pitch; artificial graphite; natural graphite; and the like. Examples of the cathode active material include lithium iron phosphate, lithium cobaltate, lithium manganate, lithium nickelate, lithium nickel cobalt manganate, a lithium nickel cobalt aluminum complex oxide, and the like. When producing an electrode for an electrical double-layer capacitor, activated carbon, activated carbon fibers, silica, alumina, or the like may be used as the active material. When producing an electrode for a lithium-ion capacitor, a carbon material (e.g., graphite, non-graphitizable carbon, hard carbon, and coke), a polyacenic organic semiconductor (PAS), or the like may be used as the active material.

### 2.2. Additive

The electrode slurry according to one embodiment of the invention may include an additive such as a thickener, a dispersant (e.g., sodium hexametaphosphate, sodium tripolyphosphate, and sodium polyacrylate), a nonionic or anionic surfactant (i.e., latex stabilizer), and an antifoaming agent.

### 2.3. Preparation of Electrode Slurry

The electrode slurry according to one embodiment of the invention preferably includes the electrode binder composition in an amount of 0.1 to 10 parts by mass (based on the solid content), and more preferably 0.5 to 5 parts by mass, based on 100 parts by mass of the active material. When the amount of the electrode binder composition is within the above range, the electrode binder composition is dissolved in the electrolyte solution to only a small extent, and a situation in which the battery characteristics are adversely affected by an increase in overvoltage can be suppressed.

When preparing the electrode slurry according to one embodiment of the invention, the electrode binder composition, the active material, and the optional additive may be mixed using a stirrer, a deaerator, a bead mill, a high-pressure homogenizer, or the like. It is preferable to prepare the electrode slurry under reduced pressure. This makes it possible to prevent a situation in which bubbles are formed in the resulting active material layer.

### 3. Electrode

An electrode according to one embodiment of the invention includes a collector and an active material layer, the active material layer being formed by applying the electrode slurry to the surface of the collector, and drying the applied electrode slurry. The electrode according to one embodiment of the invention may have a configuration in which the active material layer is formed on one side of the collector, or may have a configuration in which the active material layer is formed on each side of the collector. Since the electrode according to one embodiment of the invention includes the active material layer that is formed by applying the electrode slurry to the surface of the collector, and drying the applied electrode slurry, the electrode exhibits an excellent binding/bonding capability and excellent charge-discharge characteristics. Moreover, the electrode is highly safe, and significantly reduces the incidence of a problem in which the separator is damaged due to the particles included in the binder (i.e., the particles pass through the separator).

### 3.1. Collector

Specific examples of the collector include a metal foil, an etched metal foil, an expanded metal, and the like. Specific examples of a material for forming the collector include metal materials such as aluminum, copper, nickel, tantalum, stainless steel, and titanium. These materials may be appropriately used depending on the type of the electrical storage device. When producing an electrode for a lithium-ion secondary battery, the thickness of the collector is preferably 5 to 30 micrometers, and more preferably 8 to 25 micrometers. When producing an electrode for an electrical double-layer capacitor, the thickness of the collector is preferably 5 to 100 micrometers, more preferably 10 to 70 micrometers, and particularly preferably 15 to 30 micrometers.

### 3.2. Formation of Active Material Layer

Specific examples of a means for applying the electrode slurry include a doctor blade method, a reverse roll method, a comma bar method, a gravure method, an air knife method, and the like. The applied electrode slurry (film) is preferably dried at a temperature of 20 to 250° C., and more preferably 50 to 150° C. The drying time is preferably 1 to 120 minutes, and more preferably 5 to 60 minutes.

Specific examples of a pressing means include a high-pressure super press, soft calender, a 1-ton press, and the like. The pressing conditions are appropriately set depending on the type of the press. The active material layer thus formed has a thickness of 40 to 100 micrometers and a density of 1.3 to 2.0 g/cm³. The resulting electrode may suitably be used as an electrode for an electrical storage device such as a lithium-ion secondary battery, an electrical double-layer capacitor, or a lithium-ion capacitor.

### 4. Electrical Storage Device

An electrical storage device such as a lithium-ion secondary battery, an electrical double-layer capacitor, or a lithium-ion capacitor may be produced using the electrode according to one embodiment of the invention. When producing a lithium-ion secondary battery, for example, an electrolyte solution prepared by dissolving a lithium compound (i.e., electrolyte) in a solvent is used.

Specific examples of the electrolyte include LiClO₄, LiBF₄, LiI, LiPF₆, LiCF₃SO₃, LiAsF₆, LiSbF₆, LiAlCl₄, LiCl, LiBr, LiB(C₂H₅)₄, LiCH₃SO₃, LiC₄F₉SO₃, Li(CF₃SO₂)₂N, and the like.

Specific examples of the solvent include carbonates such as propylene carbonate, ethylene carbonate, butylene carbonate, dimethyl carbonate, diethyl carbonate, and methylethyl carbonate; lactones such as gamma-butyrolactone; ethers such as trimethoxysilane, 1,2-dimethoxyethane, diethyl ether, 2-ethoxyethane, tetrahydrofuran, and 2-methyltetrahydrofuran; sulfoxides such as dimethyl sulfoxide; oxo lanes such as 1,3-dioxolane and 4-methyl-1,3-dioxolane; nitrogen-containing compounds such as acetonitrile and nitromethane; esters such as methyl formate, methyl acetate, butyl acetate, methyl propionate, ethyl propionate, and phosphoric acid triester; glymes such as diglyme, triglyme, and tetraglyme; ketones such as acetone, diethyl ketone, methyl ethyl ketone, and methyl isobutyl ketone; sulfones such as sulfolane; oxazolidinones such as 2-methyl-2-oxazolidinone; sultones such as 1,3-propanesultone, 1,4-butanesultone, 2,4-butanesultone, and 1,8-naphthasultone; and the like.

When producing an electrical double-layer capacitor using the electrode according to one embodiment of the invention, an electrolyte solution prepared by dissolving tetraethylammonium tetrafluoroborate, triethylmethylammonium tetrafluoroborate, tetraethylammonium hexafluorophosphate, or the like (i.e., electrolyte) in a solvent (see above) is used. When producing a lithium-ion capacitor using the electrode according to one embodiment of the invention, an electrolyte solution similar to that used when producing a lithium-ion secondary battery may be used.

### 5. Examples

The invention is further described below by way of examples. Note that the invention is not limited to the following examples. In the examples and comparative examples, the unit “parts” refers to “parts by mass”, and the unit “%” refers to “mass %” unless otherwise specified.

### 5.1. Example 1

### 5.1.1. Preparation of Electrode Binder Composition

A temperature-adjustable autoclave equipped with a stirrer was charged with 200 parts of water, 0.6 parts of sodium dodecylbenzenesulfonate, 1.0 part of potassium persulfate, 0.5 parts of sodium bisulfite, 0.2 parts of an alpha-methylstyrene dimer, 0.1 parts of dodecylmercaptan, and the first-stage polymerization components shown in Table 1. The mixture was heated to 70° C., and polymerized for 2 hours. After confirming that the polymerization conversion rate was 80% or more, the second-stage polymerization components shown in Table 1 were added to the mixture over 6 hours while maintaining the reaction temperature at 70° C. 0.5 parts of an alpha-methylstyrene dimer and 0.1 parts of dodecylmercaptan were added to the mixture when 3 hours had elapsed from the start of addition of the second-stage polymerization components. After completion of the addition of the second-stage polymerization components, the mixture was heated to 80° C., and reacted for 2 hours. After completion of polymerization, the pH of the resulting latex was adjusted to 7.5, followed by the addition of 5 parts (based on the solid content) of sodium tripolyphosphate. The residual monomers were removed by water vapor distillation, and the residue was concentrated under reduced pressure until the solid content reached 50% to obtain an electrode binder composition.

The property values (see below) of the electrode binder composition were measured. The results are shown in Table 1.

### (1) Number Average Particle Size of Polymer Particles

The number average particle size of the polymer particles contained in the electrode binder composition was determined using a measurement system that utilizes the dynamic light scattering method as the measurement principle, and found to be 150 nm. A light scattering measurement system (“ALV-5000” manufactured by ALV) that utilizes a 22 mW He—Ne laser (lambda=632.8 nm) as a light source was used as the measurement system.

### (2) Gel Content

2.0 g of the electrode binder composition (aqueous dispersion) was added to 100 g of methanol to effect coagulation, and the coagulate was filtered off using a 300-mesh wire gauze. The coagulate was washed with methanol, and dried at 60° C. for 5 hours under vacuum to obtain a dried coagulate. After measuring the mass (W0 (g)) of the dried coagulate, the dried coagulate was added to 50 ml of toluene. The mixture was stirred at 50° C. for 3 hours, cooled to 25° C., and filtered through a 300-mesh wire gauze. 10 ml of the filtrate was collected, and dried on a hot plate (120° C.) until the mass of the filtrate became constant, and the mass (W1 (g)) of the dry substance was measured. The gel content (%) was calculated by the following expression (2).

Gel content (%)=((W0−W1)/W0)×100 (2)

### (3) Electrolyte Solution Swelling Ratio

Water was added to the electrode binder composition to prepare a dispersion having a solid content of 30%. 25 g (based on the solid content) of the dispersion was poured into a frame having dimensions of 8×14 cm, and dried at room temperature for 5 days to obtain a dry film. The dry film was then removed from the frame, and dried at 80° C. for 3 hours to obtain a test film. The test film was cut into dimensions of 2×2 cm, and the initial mass (W0′ (g)) was measured. The test film was then immersed in a standard electrolyte solution contained in a screw cap bottle at 80° C. for 24 hours. After removing the test film from the standard electrolyte solution, the electrolyte solution present on the surface of the test film was wiped off, and the post-immersion mass (W1′ (g)) was measured. The electrolyte solution swelling ratio was calculated by the following expression (3) using the initial mass (W0′ (g)) and the post-immersion mass (W1′ (g)) thus measured.

Electrolyte solution swelling ratio (%)=(W1′/W0′)×100 (3)

(4) pH

The pH of the electrode binder composition was measured using a pH meter (“HM-7J” manufactured by DKK-TOA Corporation), and found to be 7.5.

### 5.1.2. Production of Anode for Lithium-Ion Secondary Battery

### (1) Production Method

A twin-screw planetary mixer (“TK HIVIS MIX 2P-03” manufactured by PRIMIX Corporation) was charged with 1 part (based on the solid content) of a thickener (“CMC2200” manufactured by Daicel Corporation), 100 parts (based on the solid content) of graphite (anode active material), and 68 parts of water. The mixture was stirred at 60 rpm for 1 hour. After the addition of 1 part (based on the solid content) of the electrode binder composition, the mixture was stirred for 1 hour to obtain a paste. After the addition of water to the paste to adjust the solid content to 50%, the mixture was stirred at 200 rpm for 2 minutes, stirred at 1800 rpm for 5 minutes, and then stirred at 1800 rpm for 1.5 minutes under vacuum, using a stirrer/deaerator (“THINKY Mixer (Awatori Rentarou)” manufactured by THINKY Corporation) to prepare an electrode slurry. The electrode slurry was uniformly applied to the surface of a copper foil collector using a doctor blade method so that the thickness after drying was 80 micrometers. The electrode slurry was then dried at 120° C. for 20 minutes. The resulting film was pressed using a roll press so that the resulting active material layer had a density of 1.8 g/cm³ to obtain an anode for a lithium-ion secondary battery.

### (2) Evaluation of Binding/Bonding Capability (Measurement of Peel Strength)

A specimen having a width of 2 cm and a length of 12 cm was cut from the anode, and the surface of the active material layer of the specimen was bonded to an aluminum plate using a double-sided tape. A tape (width: 18 mm) (“CELLOTAPE (registered trademark)” manufactured by Nichiban Co., Ltd., specified in JIS Z 1522) was bonded to the surface of the collector of the specimen. A force (mN/2 cm) required to remove the tape by 2 cm at a rate of 50 mm/min and an angle of 90° was measured six times, and the average value was calculated, and taken as the peel strength (mN/2 cm). A high peel strength indicates that the adhesion between the collector and the active material layer is high (i.e., the electrode layer is not easily separated from the collector). The binding/bonding capability was evaluated as acceptable when the peel strength was 20 mN/2 cm or more.

### 5.1.3. Production of Cathode for Lithium-Ion Secondary Battery

A twin-screw planetary mixer (“TK HIVIS MIX 2P-03” manufactured by PRIMIX Corporation) was charged with 4.0 parts (based on the solid content) of an electrode binder (“KF Polymer #1120” manufactured by Kureha Corporation), 3.0 parts of a conductive aid (“DENKA BLACK” 50% pressed product, manufactured by Denki Kagaku Kohyo Kabushiki Kaisha), 100 parts (based on the solid content) of LiCoO₂ (particle size: 5 micrometers) (manufactured by Hayashi Kasei Co., Ltd.) (cathode active material), and 36 parts of N-methylpyrrolidone (NMP). The mixture was stirred at 60 rpm for 2 hours to prepare a paste. After the addition of NMP to the paste to adjust the solid content to 65%, the mixture was stirred at 200 rpm for 2 minutes, stirred at 1800 rpm for 5 minutes, and then stirred at 1800 rpm for 1.5 minutes under vacuum using a stirrer/deaerator (“THINKY Mixer (Awatori Rentarou)” manufactured by THINKY Corporation) to prepare an electrode slurry. The electrode slurry was uniformly applied to the surface of an aluminum foil collector using a doctor blade method so that the thickness after drying was 80 micrometers. The resulting film was dried at 120° C. for 20 minutes. The film was then pressed using a roll press so that the resulting electrode layer had a density of 3.0 g/cm³ to obtain a cathode for a lithium-ion secondary battery.

### 5.1.4. Production of Lithium-Ion Secondary Battery (Coin-Type Lithium-Ion Secondary Battery)

### (1) Production Method

In a glovebox of which the internal atmosphere was replaced with argon (Ar) so that the dew point was −80° C., an anode (diameter: 15.95 mm) obtained by cutting the anode produced as described above was placed on a two-electrode coin cell (“HS Flat Cell” manufactured by Hohsen Corp.). A separator (“Celgard #2400” manufactured by Celgard, LLC.) (diameter: 24 mm) obtained by cutting a polypropylene porous membrane was placed on the anode, and 500 microliters of an electrolyte solution was injected into the two-electrode coin cell while avoiding entrance of air. A cathode (diameter: 16.16 mm) obtained by cutting the cathode produced as described above was placed on the separator, and the outer casing of the two-electrode coin cell was air-tightly secured using a screw to produce a lithium-ion secondary battery according to one embodiment of the invention. Note that the electrolyte solution was prepared by dissolving LiPF₆ in ethylene carbonate/ethylmethyl carbonate (=1/1) at a concentration of 1 mol/l.

### (2) Evaluation of Charge Rate and Discharge Rate

The lithium-ion secondary battery produced as described above was charged at a constant current (0.2 C), charged at a constant voltage (4.2 V) when the voltage reached 4.2 V, and determined to be fully charged (cut-off) when the current value reached 0.01 C. The charge capacity at 0.2 C was measured. The lithium-ion secondary battery was then discharged at a constant current (0.2 C), and determined to be fully discharged (cut-off) when the voltage reached 2.7 V. The discharge capacity at 0.2 C was measured. The ratio (%) of the discharge capacity at 3 C to the discharge capacity at 0.2 C was calculated, and taken as the discharge rate characteristics (%).

The lithium-ion secondary battery was then charged at a constant current (3 C), charged at a constant voltage (4.2 V) when the voltage reached 4.2 V, and determined to be fully charged (cut-off) when the current value reached 0.01 C. The charge capacity at 3 C was measured. The lithium-ion secondary battery was then discharged at a constant current (3 C), and determined to be fully discharged (cut-off) when the voltage reached 2.7 V. The discharge capacity at 3 C was measured. The ratio (%) of the charge capacity at 3 C to the charge capacity at 0.2 C was calculated, and taken as the charge rate characteristics (%). It was determined that the film formed on the surface of the anode has low resistance, and a high-speed discharge operation can be implemented when the discharge rate characteristics and the charge rate characteristics were 80% or more.

Note that “1 C” refers to a current value at which a cell having a given capacity is discharged in 1 hour by constant-current discharging. For example, “0.1 C” refers to a current value at which the cell is discharged in 10 hours, and “10 C” refers to a current value at which the cell is discharged in 0.1 hours.

### (3) Evaluation of Cycle Characteristics

The lithium-ion secondary battery produced as described above was charged at a constant current (1 C), charged at a constant voltage (4.2 V) when the voltage reached 4.2 V, and determined to be fully charged (cut-off) when the current value reached 0.01 C. The lithium-ion secondary battery was then discharged at a constant current (1 C), and determined to be fully discharged (cut-off) when the voltage reached 3.0 V. The discharge capacity in the first cycle was calculated. The charge-discharge operation was repeated 50 times, and the discharge capacity in the fiftieth cycle was calculated. The value obtained by dividing the discharge capacity in the fiftieth cycle by the discharge capacity in the first cycle was taken as the discharge capacity retention ratio (%). The cycle characteristics were evaluated as acceptable when the discharge capacity retention ratio was 80% or more.

### 5.1.5. Production of Electrode for Electrical Double-Layer Capacitor

### (1) Production Method

A twin-screw planetary mixer (“TK HIVIS MIX 2P-03” manufactured by PRIMIX Corporation) was charged with 100 parts of activated carbon (“Kuraray Coal YP” manufactured by Kuraray Chemical Co., Ltd.), 6 parts of conductive carbon (“Denka Black” manufactured by Denki Kagaku Kogyo Kabushiki Kaisha), 2 parts of a thickener (“CMC2200” manufactured by Daicel Corporation), and 278 parts of water. The mixture was stirred at 60 rpm for 1 hour. After the addition of 4 parts of the electrode binder composition, the mixture was stirred for 1 hour to obtain a paste. After the addition of water to the paste to adjust the solid content to 25%, the mixture was stirred at 200 rpm for 2 minutes, stirred at 1800 rpm for 5 minutes, and then stirred at 1800 rpm for 1.5 minutes under vacuum, using a stirrer/deaerator (“THINKY Mixer (Awatori Rentarou)” manufactured by THINKY Corporation) to prepare an electrode slurry. The electrode slurry was uniformly applied to the surface of an aluminum foil collector using a doctor blade method so that the thickness after drying was 150 micrometers. The resulting film was dried at 120° C. for 20 minutes to obtain an electrode for an electrical double-layer capacitor.

### (2) Evaluation of Binding/Bonding Capability (Measurement of Peel Strength)

A specimen having a width of 2 cm and a length of 12 cm was cut from the electrode for an electrical double-layer capacitor, and the surface of the aluminum foil of the specimen was bonded to an aluminum plate using a double-sided tape. A tape (width: 18 mm) (“CELLOTAPE (registered trademark)” manufactured by Nichiban Co., Ltd., specified in HS Z 1522) was bonded to the surface of the active material layer of the specimen. A force (mN/2 cm) required to remove the tape by 2 cm at a rate of 50 mm/min and an angle of 90° was measured six times, and the average value was calculated, and taken as the peel strength (mN/2 cm). A high peel strength indicates that the adhesion between the collector and the active material layer is high (i.e., the active material layer is not easily separated from the collector).

### (3) Capacitor Characteristics

The electrode for an electrical double-layer capacitor that was cut to a diameter of 15.95 mm was placed on a two-electrode coin cell (“HS Flat Cell” manufactured by Hohsen Corporation) in a glovebox. A separator (“TF4535” manufactured by Nippon Kodoshi Corporation) that was cut to a diameter of 18 mm was placed on the electrode, and an electrolyte solution was injected into the two-electrode coin cell while avoiding entrance of air. The electrode for an electrical double-layer capacitor that was cut to a diameter of 16.16 mm was placed on the separator, and the outer casing of the two-electrode coin cell was air-tightly secured using a screw to produce a capacitor.

Note that the electrolyte solution was prepared by dissolving (C₂H₅)₄NBF₄ in propylene carbonate at a concentration of 1 mol/l.

### (3-1) Capacitance of Capacitor

The capacitor was charged by a constant current (10 mA/F)-constant voltage (2.7 V) method, and discharged by a constant current (10 mA/F) method to measure the capacitance (F/cm²) of the capacitor.

### (4) Internal Resistance

A value (Rᵢₙₜ) obtained by dividing the difference (deltaV) between the discharge cut-off voltage and the initial charge voltage by the discharge current was taken as an index of the internal resistance.

### 5.2. Examples 2 to 6 and Comparative Examples 1 to 5

An electrode binder composition was obtained in the same manner as in Example 1, except that the composition was changed as shown in Table 1. An anode for a lithium-ion secondary battery and an electrode for an electrical double-layer capacitor were produced in the same manner as in Example 1, except that the resulting electrode binder composition was used, and the property values (see above) were measured in the same manner as in Example 1. The measurement results are shown in Table 1.

### 5.3. Example 7

### 5.3.1. Preparation of Electrode Binder Composition

An electrode binder composition was obtained in the same manner as in Example 1, except that 1.0 part of an alpha-methylstyrene dimer and 0.3 parts of dodecylmercaptan were added when 3 hours had elapsed from the start of addition of the second-stage polymerization components.

The number average particle size, the gel content, the electrolyte solution swelling ratio, and the pH of the electrode binder composition were measured in the same manner as in Example 1. The results are shown in Table 2.

### 5.3.2. Production of Anode for Lithium-Ion Secondary Battery

An anode for a lithium-ion secondary battery was produced in the same manner as in Example 1, except that the resulting electrode binder composition was used, and the peel strength was measured in the same manner as in Example 1. The results are shown in Table 2.

### 5.3.3. Production of Cathode

A cathode for a lithium-ion secondary battery was produced in the same manner as in Example 1.

### 5.3.4. Production of Lithium-Ion Secondary Battery (Laminate-Type Lithium-Ion Secondary Battery)

### (1) Production Method

The anode that was cut to dimensions of 50×25 mm was placed on a film-shaped outer aluminum seal provided in a two-electrode laminate cell in a glovebox. A separator (“Celgard #2400” manufactured by Celgard, LLC., thickness: 25 micrometers) obtained by cutting a polypropylene porous membrane to dimensions of 54×27 mm was placed on the anode, and an electrolyte solution was injected into the cell while avoiding entrance of air. The cathode that was cut to dimensions of 48×23 mm was placed on the separator. An outer aluminum seal was then placed on the cathode. A laminate consisting of the outer aluminum seal, the anode, the separator, the cathode, and the outer aluminum seal was thus obtained. The outer aluminum seals were bonded at the outer edge using a heat sealing system to seal the laminate. An electrolyte solution was injected into the laminate while avoiding entrance of air between the layers to produce a lithium-ion secondary battery (electrochemical device) formed by the two-electrode laminate cell. Note that the electrolyte solution was prepared by dissolving LiPF₆ in ethylene carbonate/ethylmethyl carbonate (=1/1) at a concentration of 1 mol/l. The above operations were performed in the glovebox.

### (2) Evaluation of Charge Rate and Discharge Rate

The charge rate and the discharge rate were evaluated in the same manner as in Example 1. The results are shown in Table 2.

### (3) Evaluation of Cycle Characteristics

The cycle characteristics were evaluated in the same manner as in Example 1. The results are shown in Table 2.

### (4) Evaluation of Internal DC Resistance (DC-IR)

The lithium-ion secondary battery was disposed in a thermostat bath (25° C.), and charged up to 50% DOD (3.8 V) at a constant current (0.2 C). The lithium-ion secondary battery was then charged for 10 seconds at a constant current (0.5 C) to determine a change in voltage, allowed to stand for 1 minute, and discharged for 10 seconds at a constant current (0.5 C) to determine a change in voltage. The voltage when charging and discharging the lithium-ion secondary battery was determined in the same manner as described above while changing the current value from 0.5 C to 1.0 C, 2.0 C, 3.0 C, and 5.0 C. A graph was drawn by plotting the current value (A) (horizontal axis) and the voltage (V) (vertical axis), and the slope of a straight line that connects the plotted points was calculated. The slope was evaluated as the internal DC resistance (DC-IR) during charging and discharging. Note that “DOD” is the ratio of the discharge capacity to the charge capacity. For example, the expression “charged up to 50% DOD” means that the lithium-ion secondary battery is charged up to 50% of the total capacity (=100%).

### (5) Evaluation of 60° C. Cycle Characteristics

The lithium-ion secondary battery subjected to “(4) Evaluation of internal DC resistance (DC-IR)” was disposed in a thermostat bath (60° C.), charged at a constant current (2.0 C), charged at a constant voltage (4.2 V) when the voltage reached 4.2 V, and determined to be fully charged (cut-off) when the current value reached 0.01 C. The lithium-ion secondary battery was then discharged at a constant current (2.0 C), and determined to be fully discharged (cut-off) when the voltage reached 3.0 V. The discharge capacity in the first cycle was calculated. The charge-discharge operation was repeated 100 times, and the discharge capacity in the hundredth cycle was calculated. The value obtained by dividing the discharge capacity in the hundredth cycle by the discharge capacity in the first cycle was taken as the 100-cycle discharge capacity retention ratio (%). The cycle characteristics were evaluated as acceptable when the 100-cycle discharge capacity retention ratio was 40% or more.

### (6) Evaluation of Resistance Change Ratio

The internal DC resistance (DC-IR) during discharging was measured in the same manner as described above (see “(4) Evaluation of internal DC resistance (DC-IR)”) using the lithium-ion secondary battery subjected to “(5) Evaluation of 60° C. cycle characteristics”. The ratio of the internal DC resistance measured after evaluating the cycle characteristics to the internal DC resistance (DC-IR) measured before evaluating the cycle characteristics was taken as the resistance change ratio. A small resistance change ratio indicates that a deterioration in resistance is small. The resistance change ratio was evaluated as acceptable when the resistance change ratio was 10 or less.

### 5.4. Examples 8 to 22 and Comparative Examples 6 to 8

An electrode binder composition was obtained in the same manner as in Example 7, except that the composition was changed as shown in Table 2 or 3. An anode for a lithium-ion secondary battery was produced in the same manner as in Example 7, except that the resulting electrode binder composition was used, and the property values (see above) were measured in the same manner as in Example 7. The measurement results are shown in Table 2 or 3.

### 5.5. Comparative Example 9

A temperature-adjustable autoclave equipped with a stirrer was charged with 200 parts of water, 0.6 parts of sodium dodecylbenzenesulfonate, 1.0 part of potassium persulfate, 0.5 parts of sodium bisulfite, 0.2 parts of an alpha-methylstyrene dimer, 0.6 parts of dodecylmercaptan, and the first-stage polymerization components shown in Table 3. The mixture was heated to 70° C., and polymerized for 2 hours. After confirming that the polymerization conversion rate was 80% or more, the second-stage polymerization components shown in Table 3 were added to the mixture over 6 hours while maintaining the reaction temperature at 70° C. 1.0 part of an alpha-methylstyrene dimer and 0.9 parts of dodecylmercaptan were added to the mixture when 3 hours had elapsed from the start of addition of the second-stage polymerization components. After completion of the addition of the second-stage polymerization components, the mixture was heated to 80° C., and reacted for 2 hours. After completion of polymerization, the pH of the resulting latex was adjusted to 7.5, followed by the addition of 5 parts (based on the solid content) of sodium tripolyphosphate. The residual monomers were removed by water vapor distillation, and the residue was concentrated under reduced pressure until the solid content reached 50% to obtain an electrode binder composition.

An anode for a lithium-ion secondary battery was produced in the same manner as in Example 7, except that the resulting electrode binder composition was used, and the property values (see above) were measured in the same manner as in Example 7. The measurement results are shown in Table 3.

### 5.6. Comparative Example 10

A temperature-adjustable autoclave equipped with a stirrer was charged with 200 parts of water, 0.6 parts of sodium dodecylbenzenesulfonate, 1.0 part of potassium persulfate, 0.5 parts of sodium bisulfite, 0.2 parts of dodecylmercaptan, and the first-stage polymerization components shown in Table 3. The mixture was heated to 70° C., and polymerized for 2 hours. After confirming that the polymerization conversion rate was 80% or more, the second-stage polymerization components shown in Table 3 were added to the mixture over 6 hours while maintaining the reaction temperature at 70° C. 0.3 parts of dodecylmercaptan was added to the mixture when 3 hours had elapsed from the start of addition of the second-stage polymerization components. After completion of the addition of the second-stage polymerization components, the mixture was heated to 80° C., and reacted for 2 hours. After completion of polymerization, the pH of the resulting latex was adjusted to 7.5, followed by the addition of 5 parts (based on the solid content) of sodium tripolyphosphate. The residual monomers were removed by water vapor distillation, and the residue was concentrated under reduced pressure until the solid content reached 50% to obtain an electrode binder composition.

An anode for a lithium-ion secondary battery was produced in the same manner as in Example 7, except that the resulting electrode binder composition was used, and the property values (see above) were measured in the same manner as in Example 7. The measurement results are shown in Table 3.

TABLE 1

| | | | | | | | | | | Com- | Com- | Com- | Com- | Com- |
|---|---|---|---|---|---|---|---|---|---|---|---|---|---|---|
| | | | | | | | | | | par- | par- | par- | par- | par- |
| | | | | | | | | | | ative | ative | ative | ative | ative |
| | | | | Exam- | Exam- | Exam- | Exam- | Exam- | Exam- | Exam- | Exam- | Exam- | Exam- | Exam- |
| | | | Unit | ple 1 | ple 2 | ple 3 | ple 4 | ple 5 | ple 6 | ple 1 | ple 2 | ple 3 | ple 4 | ple 5 |
| First- | Compo- | Acrylo- | Parts | 0 | 0 | 0 | 0 | 0 | 0 | 0 | 0 | 0 | 0 | 0 |
| stage | nent (A) | nitrile | | | | | | | | | | | | |
| polym- | Compo- | Acrylic | Parts | 0.5 | 0.5 | 0.5 | 0.5 | 0.5 | 0.25 | 0.5 | 0.5 | 0.5 | 0.1 | 0.5 |
| erization | nent (B) | acid | | | | | | | | | | | | |
| compo- | | Itaconic | Parts | 1.5 | 1.5 | 1.5 | 1.5 | 1.5 | 0.5 | 1.5 | 1.5 | 1.5 | 0.1 | 1.5 |
| nent | | acid | | | | | | | | | | | | |
| | Compo- | Buta- | Parts | 6 | 6 | 6 | 6 | 6 | 6 | 6 | 6 | 6 | 6 | 6 |
| | nent (C) | diene | | | | | | | | | | | | |
| | Compo- | Styrene | Parts | 11.5 | 4 | 4 | 2 | 4 | 4 | 2 | 4 | 4 | 4 | 4 |
| | nent (D) | | | | | | | | | | | | | |
| | Compo- | Methyl | Parts | 3.5 | 3.5 | 3.5 | 3.5 | 3.5 | 3.5 | 2 | 3.5 | 3.5 | 3.5 | 3.5 |
| | nent (E) | meth- | | | | | | | | | | | | |
| | | acrylate | | | | | | | | | | | | |
| Total (first stage) | | | Parts | 23 | 15.5 | 15.5 | 13.5 | 15.5 | 14.25 | 12 | 15.5 | 15.5 | 13.7 | 15.5 |
| Second- | Compo- | Acrylo- | Parts | 25 | 12 | 35 | 25 | 30 | 25 | 50 | 8 | 2 | 25 | 25 |
| stage | nent (A) | nitrile | | | | | | | | | | | | |
| polym- | Compo- | Acrylic | Parts | 1.5 | 1.5 | 1.5 | 1.5 | 2.5 | 0.25 | 1.5 | 1.5 | 1.5 | 0 | 5.5 |
| erization | nent (B) | acid | | | | | | | | | | | | |
| compo- | | Itaconic | Parts | 0.5 | 0.5 | 0.5 | 0.5 | 2.5 | 0.5 | 0.5 | 0.5 | 0.5 | 0 | 4.5 |
| nent | | acid | | | | | | | | | | | | |
| | Compo- | Buta- | Parts | 34 | 34 | 34 | 44 | 34 | 34 | 34 | 34 | 34 | 34 | 34 |
| | nent (C) | diene | | | | | | | | | | | | |
| | Compo- | Styrene | Parts | 7.5 | 28 | 5 | 11 | 7 | 17.5 | 1 | 32 | 38 | 18.8 | 7 |
| | nent (D) | | | | | | | | | | | | | |
| | Compo- | Methyl | Parts | 8.5 | 8.5 | 8.5 | 4.5 | 8.5 | 8.5 | 1 | 8.5 | 8.5 | 8.5 | 8.5 |
| | nent (E) | meth- | | | | | | | | | | | | |
| | | acrylate | | | | | | | | | | | | |
| Total (second stage) | | | Parts | 77 | 84.5 | 84.5 | 86.5 | 84.5 | 85.75 | 88 | 84.5 | 84.5 | 86.3 | 84.5 |
| Total | Compo- | Acrylo- | Parts | 25 | 12 | 35 | 25 | 30 | 25 | 50 | 8 | 2 | 25 | 25 |
| (first | nent (A) | nitrile | | | | | | | | | | | | |
| stage + | Compo- | Acrylic | Parts | 2 | 2 | 2 | 2 | 3 | 0.5 | 2 | 2 | 2 | 0.1 | 6 |
| second | nent (B) | acid | | | | | | | | | | | | |
| stage) | | ltaconic | Parts | 2 | 2 | 2 | 2 | 4 | 1 | 2 | 2 | 2 | 0.1 | 6 |
| | | acid | | | | | | | | | | | | |
| | Compo- | Buta- | Parts | 40 | 40 | 40 | 50 | 40 | 40 | 40 | 40 | 40 | 40 | 40 |
| | nent (C) | diene | | | | | | | | | | | | |
| | Compo- | Styrene | Parts | 19 | 32 | 9 | 13 | 11 | 21.5 | 3 | 36 | 42 | 22.8 | 11 |
| | nent (D) | | | | | | | | | | | | | |
| | Compo- | Methyl | Parts | 12 | 12 | 12 | 8 | 12 | 12 | 3 | 12 | 12 | 12 | 12 |
| | nent (E) | meth- | | | | | | | | | | | | |
| | | acrylate | | | | | | | | | | | | |

| Total (first stage + | | Parts | 100 | 100 | 100 | 100 | 100 | 100 | 100 | 100 | 100 | 100 | 100 |
|---|---|---|---|---|---|---|---|---|---|---|---|---|---|
| second stage) | | | | | | | | | | | | | |
| Number average | | nm | 150 | 120 | 120 | 120 | 80 | 320 | 120 | 400 | 120 | 150 | 150 |
| particle size | | | | | | | | | | | | | |
| Gel content | | % | 96 | 90 | 97 | 92 | 98 | 94 | 90 | 85 | 94 | 96 | 92 |
| Electrolyte solution | | % | 200 | 300 | 150 | 350 | 200 | 250 | 500 | 150 | 110 | 200 | 600 |
| swelling ratio | | | | | | | | | | | | | |
| pH | | | 7.5 | 7.5 | 7.5 | 7.5 | 7.5 | 7.5 | 7.5 | 7.5 | 7.5 | 7.5 | 7.5 |
| Lithium- | Peel strength | mN/ | 52 | 53 | 52 | 56 | 55 | 50 | 44 | 56 | 50 | A large | 38 |
| ion sec- | | 2 cm | | | | | | | | | | | |
| ondary | Charge rate | % | 90 | 91 | 91 | 90 | 90 | 92 | 55 | 82 | 75 | amount of | 87 |
| battery | characteristics | | | | | | | | | | | | |
| | Discharge rate | % | 91 | 92 | 91 | 91 | 90 | 91 | 58 | 83 | 77 | aggregates | 86 |
| | characteristics | | | | | | | | | | | | |
| | Discharge capacity | % | 95 | 89 | 94 | 87 | 89 | 91 | 63 | 60 | 85 | were | 45 |
| | retention ratio | | | | | | | | | | | | |
| Elec- | Peel strength | mN/ | 110 | 108 | 109 | 112 | 112 | 106 | 100 | 105 | 103 | formed, | 98 |
| trical | | cm | | | | | | | | | | | |
| double- | Capacitance | F/cm² | 0.9 | 0.9 | 0.89 | 0.9 | 0.9 | 0.9 | 0.9 | 0.89 | 0.89 | and a slurry | 0.9 |
| layer | Internal resistance | Ohm | 7.9 | 8 | 7.9 | 8 | 7.8 | 8 | 9.5 | 8.9 | 9.8 | could not | 8.5 |
| capacitor | | | | | | | | | | | | be obtained. | |

TABLE 2

| | | | | Exam- | Exam- | Exam- | Exam- | Exam- | Exam- |
|---|---|---|---|---|---|---|---|---|---|
| | | | Unit | ple 7 | ple 8 | ple 9 | ple 10 | ple 11 | ple 12 |
| First- | Component (A) | Acrylonitrile | Parts | 0 | 0 | 0 | 0 | 0 | 0 |
| stage | Component (B) | Acrylic acid | Parts | 0.59 | 0.59 | 0.59 | 0.59 | 0.59 | 0.59 |
| polym- | | Itaconic acid | Parts | 2.35 | 2.35 | 2.35 | 2.35 | 2.35 | 2.35 |
| erization | Component (C) | Butadiene | Parts | 6.7 | 6.7 | 6.7 | 6.7 | 6.7 | 6.7 |
| compo- | Component (D) | Styrene | Parts | 12 | 12 | 12 | 12 | 12 | 12 |
| nent | Component (E) | Methyl | Parts | 2.6 | 2.6 | 2.6 | 2.6 | 2.6 | 2.6 |
| | | methacrylate | | | | | | | |
| | | Hydroxyethyl | Parts | 0 | 0 | 0 | 0 | 0 | 0 |
| | | methacrylate | | | | | | | |
| Total (first stage) | | | Parts | 24.24 | 24.24 | 24.24 | 24.24 | 24.24 | 24.24 |
| Second- | Component (A) | Acrylonitrile | Parts | 12 | 12 | 12 | 12 | 12 | 12 |
| stage | Component (B) | Acrylic acid | Parts | 0.36 | 0.36 | 0.36 | 0.36 | 0.36 | 0.36 |
| polym- | | Itaconic acid | Parts | 0.5 | 0.5 | 0.5 | 0.5 | 0.5 | 0.5 |
| erization | Component (C) | Butadiene | Parts | 42.3 | 42.3 | 42.3 | 42.3 | 42.3 | 42.3 |
| compo- | Component (D) | Styrene | Parts | 8 | 8 | 8 | 8 | 8 | 8 |
| nent | Component (E) | Methyl | Parts | 9.6 | 9.6 | 9.6 | 9.6 | 9.6 | 9.6 |
| | | methacrylate | | | | | | | |
| | | Hydroxyethyl | Parts | 3 | 3 | 3 | 3 | 3 | 3 |
| | | methacrylate | | | | | | | |
| Total (second stage) | | | Parts | 75.76 | 75.76 | 75.76 | 75.76 | 75.76 | 75.76 |
| Total | Component (A) | Acrylonitrile | Parts | 12 | 12 | 12 | 12 | 12 | 12 |
| (first | Component (B) | Acrylic acid | Parts | 0.95 | 0.95 | 0.95 | 0.95 | 0.95 | 0.95 |
| stage + | | Itaconic acid | Parts | 2.85 | 2.85 | 2.85 | 2.85 | 2.85 | 2.85 |
| second | Component (C) | Butadiene | Parts | 49 | 49 | 49 | 49 | 49 | 49 |
| stage) | Component (D) | Styrene | Parts | 20 | 20 | 20 | 20 | 20 | 20 |
| | Component (E) | Methyl | Parts | 12.2 | 12.2 | 12.2 | 12.2 | 12.2 | 12.2 |
| | | methacrylate | | | | | | | |
| | | Hydroxyethyl | Parts | 3 | 3 | 3 | 3 | 3 | 3 |
| | | methacrylate | | | | | | | |

| Total (first stage + second stage) | | Parts | 100 | 100 | 100 | 100 | 100 | 100 |
|---|---|---|---|---|---|---|---|---|
| Number average particle size | | nm | 90 | 50 | 70 | 120 | 200 | 90 |
| Gel content | | % | 95 | 96 | 96 | 95 | 94 | 93 |
| Electrolyte solution swelling ratio | | % | 190 | 180 | 180 | 190 | 200 | 150 |
| pH | | | 7.2 | 7.4 | 7.3 | 6.8 | 7.1 | 7.6 |
| Lithium- | Peel strength | mN/ | 32 | 31 | 31 | 34 | 33 | 22 |
| ion | | 2 cm | | | | | | |
| sec- | Charge rate characteristics | % | 91 | 90 | 92 | 91 | 91 | 90 |
| ondary | Discharge rate characteristics | % | 90 | 90 | 91 | 91 | 90 | 90 |
| battery | Discharge capacity | % | 91 | 92 | 92 | 91 | 91 | 91 |
| | retention ratio | | | | | | | |
| | 60° C. 2C cycle characteristics | % | 52 | 49 | 51 | 52 | 48 | 50 |
| | (100 cycles) | | | | | | | |
| | Resistance change ratio | — | 8 | 8.5 | 8.1 | 7.9 | 8.4 | 8.1 |

| | | | | Exam- | Exam- | Exam- | Exam- | Exam- |
|---|---|---|---|---|---|---|---|---|
| | | | Unit | ple 13 | ple 14 | ple 15 | ple 16 | ple 17 |
| First- | Component (A) | Acrylonitrile | Parts | 0 | 0 | 0 | 0 | 0 |
| stage | Component (B) | Acrylic acid | Parts | 0.59 | 0.59 | 0.59 | 0.59 | 0.59 |
| polym- | | Itaconic acid | Parts | 2.35 | 2.35 | 2.35 | 2.35 | 2.35 |
| erization | Component (C) | Butadiene | Parts | 6.7 | 6.7 | 6.7 | 6.7 | 6.7 |
| compo- | Component (D) | Styrene | Parts | 12 | 7 | 2 | 2 | 12 |
| nent | Component (E) | Methyl | Parts | 2.6 | 2.6 | 2.6 | 2.6 | 2.6 |
| | | methacrylate | | | | | | |
| | | Hydroxyethyl | Parts | 0 | 0 | 0 | 0 | 0 |
| | | methacrylate | | | | | | |
| Total (first stage) | | | Parts | 24.24 | 19.24 | 14.24 | 14.24 | 24.24 |
| Second- | Component (A) | Acrylonitrile | Parts | 12 | 25 | 30 | 35 | 12 |
| stage | Component (B) | Acrylic acid | Parts | 0.36 | 0.36 | 0.36 | 0.36 | 0.36 |
| polym- | | Itaconic acid | Parts | 0.5 | 0.5 | 0.5 | 0.5 | 0.5 |
| erization | Component (C) | Butadiene | Parts | 42.3 | 42.3 | 42.3 | 42.3 | 42.3 |
| compo- | Component (D) | Styrene | Parts | 8 | 0 | 0 | 0 | 10 |
| nent | Component (E) | Methyl | Parts | 9.6 | 9.6 | 9.6 | 4.6 | 9.6 |
| | | methacrylate | | | | | | |
| | | Hydroxyethyl | Parts | 3 | 3 | 3 | 3 | 1 |
| | | methacrylate | | | | | | |
| Total (second stage) | | | Parts | 75.76 | 80.76 | 85.76 | 85.76 | 75.76 |
| Total | Component (A) | Acrylonitrile | Parts | 12 | 25 | 30 | 35 | 12 |
| (first | Component (B) | Acrylic acid | Parts | 0.95 | 0.95 | 0.95 | 0.95 | 0.95 |
| stage + | | Itaconic acid | Parts | 2.85 | 2.85 | 2.85 | 2.85 | 2.85 |
| second | Component (C) | Butadiene | Parts | 49 | 49 | 49 | 49 | 49 |
| stage) | Component (D) | Styrene | Parts | 20 | 7 | 2 | 2 | 22 |
| | Component (E) | Methyl | Parts | 12.2 | 12.2 | 12.2 | 7.2 | 12.2 |
| | | methacrylate | | | | | | |
| | | Hydroxyethyl | Parts | 3 | 3 | 3 | 3 | 1 |
| | | methacrylate | | | | | | |

| Total (first stage + second stage) | | Parts | 100 | 100 | 100 | 100 | 100 |
|---|---|---|---|---|---|---|---|
| Number average particle size | | nm | 90 | 90 | 90 | 90 | 90 |
| Gel content | | % | 96 | 93 | 94 | 95 | 95 |
| Electrolyte solution swelling ratio | | % | 150 | 300 | 340 | 380 | 190 |
| pH | | | 6.4 | 7.1 | 6.8 | 6.6 | 7.5 |
| Lithium- | Peel strength | mN/ | 31 | 34 | 32 | 26 | 28 |
| ion | | 2 cm | 91 | 90 | 90 | 90 | 90 |
| sec- | Charge rate characteristics | % | 90 | 91 | 91 | 90 | 90 |
| ondary | Discharge rate characteristics | % | 92 | 93 | 92 | 91 | 89 |
| battery | Discharge capacity | % | | | | | |
| | retention ratio | | 51 | 52 | 51 | 51 | 51 |
| | 60° C. 2C cycle characteristics | % | | | | | |
| | (100 cycles) | | 8 | 8 | 8.1 | 8.2 | 8.2 |
| | Resistance change ratio | — | | | | | |

TABLE 3

| | | | | Exam- | Exam- | Exam- | Exam- | Exam- |
|---|---|---|---|---|---|---|---|---|
| | | | Unit | ple 18 | ple 19 | ple 20 | ple 21 | ple 22 |
| First- | Component (A) | Acrylonitrile | Parts | 0 | 0 | 0 | 0 | 0 |
| stage | Component (B) | Acrylic acid | Parts | 0.59 | 0.59 | 0.59 | 0.59 | 0.59 |
| polym- | | Itaconic acid | Parts | 2.35 | 2.35 | 2.35 | 2.35 | 2.35 |
| erization | Component (C) | Butadiene | Parts | 6.7 | 6.7 | 6.7 | 6.7 | 6.7 |
| compo- | Component (D) | Styrene | Parts | 12 | 12 | 12 | 12 | 12 |
| nent | Component (E) | Methyl | Parts | 2.6 | 2.6 | 2.6 | 2.6 | 2.6 |
| | | methacrylate | | | | | | |
| | | Hydroxyethyl | Parts | 0 | 0 | 0 | 0 | 0 |
| | | methacrylate | | | | | | |
| Total (first stage) | | | Parts | 24.24 | 24.24 | 24.24 | 24.24 | 24.24 |
| Second- | Component (A) | Acrylonitrile | Parts | 12 | 12 | 12 | 12 | 12 |
| stage | Component (B) | Acrylic acid | Parts | 0.36 | 0.36 | 0.36 | 0.36 | 036 |
| polym | | Itaconic acid | Parts | 0.5 | 0.5 | 0.5 | 0.5 | 0.5 |
| erization | Component (C) | Butadiene | Parts | 42.3 | 42.3 | 42.3 | 42.3 | 42.3 |
| compo- | Component (D) | Styrene | Parts | 10 | 9 | 6 | 8 | 8 |
| nent | Component (E) | Methyl | Parts | 9.6 | 9.6 | 9.6 | 9.6 | 9.6 |
| | | methacrylate | | | | | | |
| | | Hydroxyethyl | Parts | 1 | 2 | 5 | 3 | 3 |
| | | methacrylate | | | | | | |
| Total (second stage) | | | Parts | 75.76 | 75.76 | 75.76 | 75.76 | 75.76 |
| Total | Component (A) | Acrylonitrile | Parts | 12 | 12 | 12 | 12 | 12 |
| (first | Component (B) | Acrylic acid | Parts | 0.95 | 0.95 | 0.95 | 0.95 | 0.95 |
| stage + | | Itaconic acid | Parts | 2.85 | 2.85 | 2.85 | 2.85 | 2.85 |
| second | Component (C) | Butadiene | Parts | 49 | 49 | 49 | 49 | 49 |
| stage) | Component (D) | Styrene | Parts | 22 | 21 | 18 | 20 | 20 |
| | Component (E) | Methyl | Parts | 12.2 | 12.2 | 12.2 | 12.2 | 12.2 |
| | | methacrylate | | | | | | |
| | | Hydroxyethyl | Parts | 1 | 2 | 5 | 3 | 3 |
| | | methacrylate | | | | | | |
| Total (first stage + second stage) | | | Parts | 100 | 100 | 100 | 100 | 100 |
| Number average particle size | | | nm | 90 | 90 | 90 | 300 | 350 |
| Gel content | | | % | 95 | 94 | 96 | 94 | 93 |
| Electrolyte solution swelling ratio | | | % | 190 | 200 | 180 | 200 | 210 |
| pH | | | | 7.8 | 7.4 | 7.2 | 7.2 | 7.8 |
| Lithium- | Peel strength | | mN/ | 32 | 31 | 29 | 34 | 33 |
| ion | | | 2 cm | | | | | |
| sec- | Charge rate characteristics | | % | 91 | 91 | 90 | 89 | 89 |
| ondary | Discharge rate characteristics | | % | 90 | 91 | 89 | 90 | 89 |
| battery | Discharge capacity retention ratio | | % | 92 | 94 | 92 | 92 | 91 |
| | 60° C. 2C cycle characteristics | | % | 52 | 51 | 51 | 51 | 50 |
| | (100 cycles) | | | | | | | |
| | Resistance change ratio | | — | 8 | 8.2 | 8.2 | 8.1 | 8.2 |
| | | | | Compar- | Compar- | Compar- | Compar- | Compar- |
| | | | | ative | ative | ative | ative | ative |
| | | | | Exam- | Exam- | Exam- | Exam- | Exam- |
| | | | Unit | ple 6 | ple 7 | ple 8 | ple 9 | ple 10 |
| First- | Component (A) | Acrylonitrile | Parts | 0 | 0 | 0 | 0 | 0 |
| stage | Component (B) | Acrylic acid | Parts | 0.59 | 0.59 | 0.59 | 0.59 | 0.59 |
| polym- | | Itaconic acid | Parts | 2.35 | 2.35 | 2.35 | 2.35 | 2.35 |
| erization | Component (C) | Butadiene | Parts | 6.7 | 6.7 | 6.7 | 6.7 | 6.7 |
| compo- | Component (D) | Styrene | Parts | 12 | 0 | 12 | 12 | 12 |
| nent | Component (E) | Methyl | Parts | 2.6 | 2.6 | 2.6 | 2.6 | 2.6 |
| | | methacrylate | | | | | | |
| | | Hydroxyethyl | Parts | 0 | 0 | 0 | 0 | 0 |
| | | methacrylate | | | | | | |
| Total (first stage) | | | Parts | 24.24 | 12.24 | 24.24 | 24.24 | 24.24 |
| Second- | Component (A) | Acrylonitrile | Parts | 12 | 50 | 1 | 12 | 12 |
| stage | Component (B) | Acrylic acid | Parts | 0.36 | 0.36 | 0.36 | 0.36 | 0.36 |
| polym | | Itaconic acid | Parts | 0.5 | 0.5 | 0.5 | 0.5 | 0.5 |
| erization | Component (C) | Butadiene | Parts | 42.3 | 24.3 | 42.3 | 42.3 | 42.3 |
| compo- | Component (D) | Styrene | Parts | 8 | 0 | 19 | 8 | 8 |
| nent | Component (E) | Methyl | Parts | 9.6 | 9.6 | 9.6 | 9.6 | 9.6 |
| | | methacrylate | | | | | | |
| | | Hydroxyethyl | Parts | 3 | 3 | 3 | 3 | 3 |
| | | methacrylate | | | | | | |
| Total (second stage) | | | Parts | 75.76 | 87.76 | 75.76 | 75.76 | 75.76 |
| Total | Component (A) | Acrylonitrile | Parts | 12 | 50 | 1 | 12 | 12 |
| (first | Component (B) | Acrylic acid | Parts | 0.95 | 0.95 | 0.95 | 0.95 | 0.95 |
| stage + | | Itaconic acid | Parts | 2.85 | 2.85 | 2.85 | 2.85 | 2.85 |
| second | Component (C) | Butadiene | Parts | 49 | 31 | 49 | 49 | 49 |
| stage) | Component (D) | Styrene | Parts | 20 | 0 | 31 | 20 | 20 |
| | Component (E) | Methyl | Parts | 12.2 | 12.2 | 12.2 | 12.2 | 12.2 |
| | | methacrylate | | | | | | |
| | | Hydroxyethyl | Parts | 3 | 3 | 3 | 3 | 3 |
| | | methacrylate | | | | | | |

| Total (first stage + second stage) | | Parts | 100 | 100 | 100 | 100 | 100 |
|---|---|---|---|---|---|---|---|
| Number average particle size | | nm | 40 | 90 | 90 | 90 | 90 |
| Gel content | | % | 96 | 94 | 93 | 85 | 99.5 |
| Electrolyte solution swelling ratio | | % | 180 | 500 | 105 | 290 | 140 |
| pH | | | 5.5 | 7.1 | 7.5 | 7.2 | 7.2 |
| Lithium- | Peel strength | mN/ | 10 | 15 | 16 | 28 | 22 |
| ion | | 2 cm | | | | | |
| sec- | Charge rate characteristics | % | 75 | 55 | 65 | 74 | 72 |
| ondary | Discharge rate characteristics | % | 73 | 58 | 64 | 73 | 74 |
| battery | Discharge capacity retention ratio | % | 74 | 63 | 60 | 72 | 71 |
| | 60° C. 2C cycle characteristics | % | 36 | 32 | 35 | 44 | 40 |
| | (100 cycles) | | | | | | |
| | Resistance change ratio | — | 13.8 | 15 | 12 | 10 | 9.5 |

As shown in Tables 1 to 3, the electrode binder compositions of Examples 1 to 22 exhibited excellent characteristics (i.e., capability to bond the collector and the active material layer of the lithium-ion secondary battery, charge-discharge rate characteristics, cycle characteristics, capability to bond the collector and the electrode layer of the electrical double-layer capacitor, and internal resistance) as compared with the electrode binder compositions of Comparative Examples 1 to 10.

### 5.7. Experimental Example 1

The difference in performance due to the presence or absence of a filtration step was evaluated as described below using the electrode binder composition prepared in Example 1.

The electrode binder composition prepared in Example 1 was filtered using the filtration system 100 illustrated in FIG. 1 (filtration step). The filtration system 100 illustrated in FIG. 1 includes a supply tank 1 that stores and supplies the electrode binder composition from which foreign substances have not been removed, a constant volume pump 2 that discharges the electrode binder composition (from which foreign substances have not been removed) at a constant flow rate, a filter 4 that includes a cartridge filter (not illustrated in FIG. 1) and a housing that receives (is fitted with) the cartridge filter, a pulsation protector 3 that is disposed between the constant volume pump 2 and the filter 4, a first manometer 7a that is disposed between the pulsation protector 3 and the filter 4, and a second manometer 7b that is disposed on the downstream side of the filter 4. The filtration system 100 also includes a return conduit 6 that returns the binder from the filter 4 to the supply tank 1, and a discharge conduit 5 that discharges the electrode binder composition filtered through the filter 4.

In Experimental Example 1, a depth-type cartridge filter “Profile II” (manufactured by Pall Corporation, nominal filtration rating: 10 micrometers, length: 1 inch) provided in a housing was used as the filter 4. An air-driven diaphragm pump was used as the constant volume pump 2, and the differential pressure across the filter was set to 0.34 MPaG. The electrode binder composition did not show a change in number average particle size due to filtration using the filtration system 100 illustrated in FIG. 1. The number average particle size was measured using a fiber-optics particle analyzer “FPAR-1000” (manufactured by Otsuka Electronics Co., Ltd., provided with an autosampler).

When a change in number average particle size due to removal of foreign substances (filtration step) is not observed, it is determined that the electrode binder composition does not show a change in binder characteristics (i.e., the electrode binder composition maintains functions equal to those of a known binder).

The number (per ml) of particles contained in the unfiltered electrode binder composition and the filtered electrode binder composition was measured as described below. A lithium-ion secondary battery was produced using the unfiltered electrode binder composition and the filtered electrode binder composition, and the yield was calculated as described below. The evaluation results are shown in Table 4.

### (1) Measurement of Number (Per Ml) of Particles

A particle size distribution analyzer “Accusizer 780APS” (manufactured by Particle Sizing Systems) was used as a particle counter. A blank measurement was repeated using ultrapure water until the number of large particles measured became “4000 per ml (0.56 micrometers)” (i.e., the number of particles having a particle size of more than 0.56 micrometers was 4000 or less per ml). 100 ml of the binder (sample) that was 100-fold diluted with ultrapure water was provided, and placed in the particle size distribution analyzer. The particle size distribution analyzer automatically diluted the sample to the optimum concentration. The particle size distribution analyzer then measured the number (per ml) of particles in the sample twice, and calculated the average value. The average value was multiplied by 100, and taken as the number (per ml) of particles contained in the binder.

### (2) Presence or Absence of Hard Short Circuit

One hundred secondary batteries were produced in the same manner as in Example 1, and subjected to a 60° C. storage test. Specifically, the secondary batteries were charged by a constant current (0.2 C)-constant voltage (4.2 V) method, discharged by a constant current (0.2 C) method, charged by a constant current (0.2 C)-constant voltage (4.2 V) method, and allowed to stand in a thermostat bath (60° C.) for 30 days. The open-circuit voltage (OCV) of each secondary battery was then measured. A decrease in OCV was evaluated as an index of a hard short circuit. Specifically, it was determined that a hard short circuit did not occur when a significant decrease in voltage was not observed (i.e., when a decrease in OCV was not observed), and it was determined that a hard short circuit occurred when a rapid decrease in voltage was observed (i.e., when an instantaneous decrease in voltage was observed).

### (3) Yield (%)

The yield (%) of the secondary batteries was calculated based on the evaluation of the presence or absence of a hard short circuit. Specifically, the yield (%) of the secondary batteries was calculated by “[{(number of secondary batteries subjected to hard short circuit test)-(number of secondary batteries that underwent hard short circuit)}/(number of secondary batteries subjected to hard short circuit test)]×100”. It is preferable that the yield (%) be 98% or more. Note that it is more preferable that the yield (%) be 99% or more since productivity is further improved.

TABLE 4

| | | Experimental Example 1 | |
|---|---|---|---|
| | | Before | After |
| | | filtration | filtration |
| Number of | 20 micrometers or more | 400 | 0 |
| particles | 15 micrometers or more and less | 1200 | 0 |
| (/ml) | than 20 micrometers | | |
| | More than 10 micrometers and | 2100 | 0 |
| | less than 15 micrometers | | |

| | | |
|---|---|---|
| Yield (%) | 98.5 | 99.9 |

As shown in Table 4, when the electrode binder composition was filtered using the filtration system 100, the number (per ml) of particles having a particle size of 20 micrometers or more, the number (per ml) of particles having a particle size of 15 micrometers or more and less than 20 micrometers, and the number (per ml) of particles having a particle size of more than 10 micrometers and less than 15 micrometers (measured using the particle counter) were zero. The number (per ml) of particles having a particle size of 20 micrometers or more, the number (per ml) of particles having a particle size of 15 micrometers or more and less than 20 micrometers, and the number (per ml) of particles having a particle size of more than 10 micrometers and less than 15 micrometers were significantly reduced by the filtration step. As a result, the yield (%) of the secondary batteries was improved to 99.9% (i.e., productivity is significantly improved).

### 5.8. Experimental Example 2

The electrode binder composition obtained in Example 1 was filtered using the filtration system 100 illustrated in FIG. 1. In Experimental Example 2, a depth-type cartridge filter “Profile II” (manufactured by Pall Corporation, nominal filtration rating: 20 micrometers, length: 1 inch) was used as the filter 4 instead of a depth-type cartridge filter “Profile II” (manufactured by Pall Corporation, nominal filtration rating: 10 micrometers, length: 1 inch) used in Experimental Example 1. The differential pressure across the filter was set to 0.25 MPaG. The electrode binder composition did not show a change in number average particle size due to filtration. The unfiltered electrode binder composition and the filtered electrode binder composition were evaluated as described above. The evaluation results are shown in Table 5.

TABLE 5

| | | Experimental Example 2 | |
|---|---|---|---|
| | | Before | After |
| | | filtration | filtration |
| Number of | 20 micrometers or more | 500 | 0 |
| particles | 15 micrometers or more and less | 1500 | 100 |
| (/ml) | than 20 micrometers | | |
| | More than 10 micrometers and | 2300 | 280 |
| | less than 15 micrometers | | |

| | | |
|---|---|---|
| Yield (%) | 98.4 | 99.9 |

As shown in Table 5, when the electrode binder composition was filtered using the filtration system 100, the number (per ml) of particles having a particle size of 20 micrometers or more, the number (per ml) of particles having a particle size of 15 micrometers or more and less than 20 micrometers, and the number (per ml) of particles having a particle size of more than 10 micrometers and less than 15 micrometers (measured using the particle counter) were significantly reduced. As a result, the yield (%) of the secondary batteries was improved to 99.9% (i.e., productivity is significantly improved).

### 5.9. Experimental Example 3

The electrode binder composition obtained in Example 1 was filtered in the same manner as in Experimental Example 1 using the filtration system 100 illustrated in FIG. 1. In Experimental Example 3, the differential pressure across the filter was set to 0.38 MPaG, and the filtrate was sampled when 5 minutes had elapsed from the start of filtration using the filtration system 100. The unfiltered electrode binder composition and the filtered electrode binder composition were evaluated as described above. The evaluation results are shown in Table 6. The electrode binder composition did not show a change in number average particle size due to filtration.

### 5.10. Experimental Example 4

A filtrate (electrode binder composition filtered using the filtration system) was sampled in the same in the same manner as in Experimental Example 3, except that the filtrate was sampled when 10 minutes had elapsed from the start of filtration. The filtrate was evaluated as described above. The evaluation results are shown in Table 6. The electrode binder composition did not show a change in number average particle size due to filtration.

### 5.11. Experimental Example 5

A filtrate (electrode binder composition filtered using the filtration system) was sampled in the same in the same manner as in Experimental Example 3, except that the filtrate was sampled when 15 minutes had elapsed from the start of filtration. The filtrate was evaluated as described above. The evaluation results are shown in Table 6. The electrode binder composition did not show a change in number average particle size due to filtration.

TABLE 6

| | | | | Experi- | Experi- |
|---|---|---|---|---|---|
| | | Experimental | | mental | mental |
| | | Example 3 | | Example 4 | Example 5 |
| | | Before | After | After | After |
| | | filtra- | filtra- | filtra- | filtra- |
| | | tion | tion | tion | tion |
| Number of | 20 micrometers or | 700 | 0 | 0 | 0 |
| particles | more | | | | |
| (/ml) | 15 micrometers or | 2000 | 0 | 0 | 0 |
| | more and less than | | | | |
| | 20 micrometers | | | | |
| | More than 10 | 2200 | 300 | 260 | 220 |
| | micrometers and | | | | |
| | less than 15 mi- | | | | |
| | crometers | | | | |

| | | | | |
|---|---|---|---|---|
| Yield (%) | 98.2 | 99.9 | 99.9 | 99.9 |

As shown in Tables 4 to 6, it was confirmed that the electrode binder composition subjected to the filtration step can be used as a material for forming an electrode for an electrochemical device that is highly safe, and significantly reduces the incidence of a problem in which the separator is damaged.

### 5.12. Experimental Example 7 (Electrode Binder Composition Storage Test)

The electrode binder composition obtained in Example 1, 2, or 3 was put in a storage container, and stored for 6 months under the conditions (void ratio, storage temperature, and oxygen concentration in gas contained in container) shown in Table 7. After storing the electrode binder composition for 6 months, the presence or absence of foreign substances in the electrode binder composition, and the state of the storage container were determined by naked eye observation. The results are shown in Table 7. Note that the oxygen concentration was adjusted by injecting high-purity nitrogen into the storage container containing the electrode binder composition.

“Clean bottle” in Table 7 refers to a 20-liter square clean bottle manufactured by Aicello Chemical Co., Ltd. “Cleaned plastic container” in Table 7 refers to a commercially available 20-liter square polypropylene container, the inside of which was washed in a clean room. “Metal can” in Table 7 refers to a commercially available 18-liter square metal can. A case where aggregates were observed with the naked eye was evaluated as “Unacceptable”, and a case where aggregates were not observed with the naked eye was evaluated as “Acceptable”. A case where a change in the external appearance of the container was not observed with the naked eye was evaluated as “Acceptable”, and a case where a change in the external appearance of the container was observed with the naked eye was evaluated as “Unacceptable”. The presence or absence of a hard short circuit and the yield were evaluated as described above.

TABLE 7

| Electrode binder | | Binder of | Binder of | Binder of | Binder of | Binder of | Binder of |
|---|---|---|---|---|---|---|---|
| composition | | Example 1 | Example 2 | Example 3 | Example 1 | Example 2 | Example 3 |
| Storage container | | Clean bottle | Cleaned plastic | Clean bottle | Metal can | Cleaned plastic | Metal can |
| | | | container | | | container | |
| Storage temperature (° C.) | | 20 | 5 | 20 | 60 | −20 | 30 |
| Void ratio (%) | | 5 | 10 | 5 | 0.5 | 0.5 | 10 |
| Oxygen concentration | | 50 ppm | 500 ppm | 500 ppm | 50 ppm | 50 ppm | 18% |
| Storage | Foreign | Acceptable | Acceptable | Acceptable | Unacceptable | Unacceptable | Unacceptable |
| stability | substance | | | | | | |
| (6 months) | State of | Acceptable | Acceptable | Acceptable | Unacceptable | Unacceptable | Acceptable |
| | container | | | (leakage/ | (leakage/ | | |
| | | | | deformation) | deformation) | | |

| | | | | | | |
|---|---|---|---|---|---|---|
| Hard short circuit | No | No | No | Yes | Yes | Yes |
| Yield (%) | 99 | 99 | 99 | 95 | 91 | 93 |

As is clear from the results shown in Table 7, it was confirmed that the method for storing an electrode binder composition according to one embodiment of the invention was effective.

The invention is not limited to the above embodiments. Various modifications and variations may be made of the above embodiments. For example, the invention includes various other configurations substantially the same as the configurations described in connection with the above embodiments (e.g., a configuration having the same function, method, and results, or a configuration having the same objective and results). The invention also includes a configuration in which an unsubstantial part (element) described in connection with the above embodiments is replaced with another part (element). The invention also includes a configuration having the same effects as those of the configurations described in connection with the above embodiments, and a configuration capable of achieving the same objective as that of the configurations described in connection with the above embodiments. The invention further includes a configuration in which a known technique is added to the configurations described in connection with the above embodiments.

### INDUSTRIAL APPLICABILITY

The electrode binder composition according to the embodiments of the invention may suitably be used as a material for forming an electrode for an electrochemical device used as a power supply for driving an electronic instrument, for example. The electrode slurry according to the embodiments of the invention may suitably be used as a material for forming an electrode for an electrochemical device used as a power supply for driving an electronic instrument, for example. The electrode according to the embodiments of the invention may suitably be used as an electrode for an electrochemical device used as a power supply for driving an electronic instrument, for example. The method for producing an electrode binder composition according to the embodiments of the invention may be used to produce an electrode binder that is used as a material for forming an electrode for an electrochemical device used as a power supply for driving an electronic instrument, for example.

### REFERENCE SIGNS LIST

1: supply tank, 2: constant volume pump, 3: pulsation protector, 4: filter, 5: discharge conduit, 6: return conduit, 7a: first manometer, 7b: second manometer, 100: filtration system

1. An electrode binder composition, comprising:
polymer particles,
wherein the polymer particles comprise from 5 to 40 parts by mass of a constituent unit (A) derived from an alpha,beta-unsaturated nitrile compound and from 0.3 to 10 parts by mass of a constituent unit (B) derived from an unsaturated carboxylic acid, and having a number average particle size of from 50 to 400 nm, and
wherein the electrode binder composition has a gel content of from 90 to 99% and an electrolyte solution swelling ratio of from 110 to 400%.

2. The electrode binder composition according to claim 1,
wherein the polymer particles further comprise a constituent unit derived from a compound represented by formula: 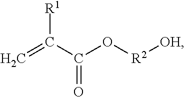
wherein R¹ is a hydrogen atom or a monovalent hydrocarbon group, and
R² is a divalent hydrocarbon group.

3. The electrode binder composition according to claim 2,
wherein the compound is hydroxyethyl methacrylate.

4. The electrode binder composition according to claim 1,
wherein the polymer particles further comprise a constituent unit (C) derived from a conjugated diene compound.

5. The electrode binder composition according to claim 1,
wherein the electrode binder composition has a pH of from 6 to 8.

6. The electrode binder composition according to claim 1, wherein a number of particles having a particle size of 20 micrometers or more measured with a particle counter is zero.

7. A method for producing the electrode binder composition according to claim 6, the method comprising:
filtering the electrode binder composition so that the number of particles having a particle size of 20 micrometers or more measured with a particle counter is zero.

8. An electrode slurry, comprising:
an active material and
the electrode binder composition according to claim 1.

9. An electrode, comprising:
a collector and
an active material layer,
wherein the active material layer is formed by a process comprising applying the electrode slurry according to claim 8 to a surface of the collector, thereby forming an applied electrode slurry and drying the applied electrode slurry.

10. An electrochemical device, comprising:
the electrode according to claim 9.

11. A method for storing an electrode binder composition, comprising:
charging a container that is controlled at a temperature of from 2 to 30° C. with the electrode binder composition according to claim 1 so that a ratio of a volume of a void to an internal volume of the container is from 1 to 20%,
wherein the volume of the void is calculated by subtracting a volume occupied by the electrode binder composition from the internal volume of the container.

12. The method according to claim 11,
wherein an oxygen concentration in an atmosphere contained in the void is 1% or less.

13. The method according to claim 11, wherein elution of metal ions from the container occurs at a concentration of 50 ppm or less.
